(19) United States
(12) Patent Application Publication
(10) Pub. No.: US 2025/0197778 A1
(43) Pub. Date: Jun. 19, 2025

(54) STORAGE STABILIZATION AGENT FOR AQUEOUS HOME CARE FORMULATIONS

(71) Applicant: Omya International AG, Oftringen (CH)

(72) Inventors: Jamal FTOUNI, Zofingen (CH); Julia IVANOV, Binningen (CH); Klaus SÜTTERLIN, Buggingen (DE); Joachim GLAUBITZ, Murgenthal (CH)

(73) Assignee: Omya International AG, Oftringen (CH)

(21) Appl. No.: 18/867,055

(22) PCT Filed: Jun. 14, 2023
(86) PCT No.: PCT/EP2023/065972

§ 371 Date: Nov. 19, 2024

(30) Foreign Application Priority Data
Jun. 15, 2022 (EP) 22179173.4

(51) Int. Cl. C11D 3/48; A01N 59/06; A01P 3/00; A01P 13/00; C11D 3/10; C11D 3/12; C11D 3/20

(52) U.S. Cl. CPC C11D 3/48; A01N 59/06; A01P 3/00; A01P 13/00; C11D 3/10; C11D 3/1213; C11D 3/2086

(57) ABSTRACT

The present invention relates to the use of a storage stabilization agent for stabilizing an aqueous home care formulation upon storage, wherein the storage stabilization agent comprises at least two different water soluble or water dispersible ion sources selected from the group consisting of water soluble or water dispersible source of bismuth ions, water soluble or water dispersible source of lithium ions, water soluble or water dispersible source of magnesium ions and at least a water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

The present invention relates to the use of a storage stabilization agent for stabilizing an aqueous home care formulation upon storage, wherein the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(_{CO3})₄(OH)₂·4H₂O). Furthermore, the present invention relates to a storage stabilization agent for stabilizing an aqueous home care formulation upon storage, an aqueous home care formulation comprising the inventive storage stabilization agent as well as a process for stabilizing an aqueous home care formulation upon storage.

### BACKGROUND

In practice, aqueous home care formulations, for example liquid soaps and liquid cleaning compositions such as laundry and hand wash formulations, cream cleaners or dish wash products are present in nearly every household, as well as many industries, in medical practices, laundry facilities, canteens, restaurants etc. In fact, a large number of human beings has a daily contact with such aqueous home care formulations.

Typical aqueous preparations of aqueous home care formulations are, for example, known from WO2021239453 that refers to liquid laundry compositions, CN112625809 that refers to a dishwasher body detergent liquid composition and a preparation method thereof, JP2021066679 that refers to a liquid bath salt composition for bubble bath, or US2020407666 that refers to an organic liquid and foaming soap composition and dispenser for use as a human hand, body wash and a pet wash.

The aforementioned aqueous home care formulations are often stored, for example, in bottles, tetra Paks™, containers, big packs or tanks before shipping. Furthermore, the aforementioned aqueous home care formulations are also often stored after shipping to the retailers or end consumers. However, during storing there might be changes in the preparation properties such as changes in pH. Further changes that might occur are changes in the viscosity, discolorations or reductions in other quality parameters, which negatively affect the commercial value of the aforementioned aqueous home care formulations. Furthermore, during storage there might occur microbial growth in such aqueous home care formulations, which means that these aqueous home care formulations are subject to contamination by microorganisms such as fungi, yeasts, molds, protozoa and/or aerobic and anaerobic bacteria. Such contamination by microorganisms is, depending on the species, a risk to humans, animals and/or crops.

Therefore, the manufacturers of such aqueous home care formulations usually take measures for stabilising the suspensions, dispersions or slurries upon storage by using storage stabilizers, such as, for example, pH stabilizers and/or antimicrobial agents or biocides. Such antimicrobials or biocides that preserve aqueous home care formulations against microorganisms are well known in the art such as phenols, halogenated phenols, halogen-containing compounds, halogen-releasing compounds, isothiazolinones, aldehyde-containing compounds, aldehyde-releasing compounds, guanidines, sulfones, thiocyanates, pyrithiones, antibiotics such as β-lactam antibiotics, quaternary ammonium salts, peroxides, perchlorates, amides, amines, heavy metals, biocidal enzymes, biocidal polypeptides, azoles, carbamates, glyphosates, sulphonamides and mixtures thereof.

One of the most common substances for preservation and stabilization belong to the chemical group of isothiazolinones, such as methylisothiazolinone (MIT, MI), chloromethylisothiazolinone (CMIT, CMI, MCI), benzisothiazolinone (BIT), octylisothiazolinone (OIT, OI), dichlorooctylisothiazolinone (DCOIT, DCOI), or butylbenzisothiazolinone (BBIT). For example, CN107582441 refers to a liquid hand sanitizer comprising methylisothiazolinone, EP3606345 discloses stabilized biocide compositions, that might be used as cleaning products that comprise 2.5 to 15 wt. % of isothiazolinones.

US2021/269630 A1 refers to a process for preparing stable polymers containing vinylimidazole. In this document aqueous mixtures including water, 1-vinylimidazole-containing polymer(s) (P) and quaternary ammonium salts (QA) are described. The quaternary ammonium salts are used as biocides for stabilizing the 1-vinylimidazole-containing polymer(s).

However, such known storage stabilizers often have risks for the environment and human or animal health in the quantities used and, therefore, may be seen as harmful substances for the humans/animals and the environment. Therefore, the use of such storage stabilization agents in aqueous home care formulations is subject to continuously increasing limitations. For example, together with their wanted function, namely controlling or killing microorganisms, isothiazolinones also have undesirable effects such as a high allergenic potential and high aquatic toxicity. Lately it is also suspected that isothiazolinones may cause dermatitis. Since their undesirable effects often outweigh their benefits, many countries are looking at partial or full bans of the substance due to the known dangers in using such biocides.

Replacement of such antimicrobials or biocides that preserve aqueous home care formulations against microorganisms by other substances such as, for example, potassium sorbate does often not reduce or inhibit microbial growth in liquid detergents due to the high pH value. Sometimes such antimicrobials or biocides are replaced by the addition of zinc ions as described, for example, in US2020/163340. However, the presence of zinc ions in such compositions has to be avoided in some technical fields due to regulation requirements. Furthermore, U.S. Ser. No. 10/624,348 is known that uses different alkali ions for preparing an antiseptic product.

Therefore, there is still a need in the art for storage stabilization agents that preserve aqueous home care formulations but avoid, or at least reduce, the use of conventional antimicrobials such as phenols, halogenated phenols, halogen-containing compounds, halogen-releasing compounds, isothiazolinones, aldehyde-containing compounds, aldehyde-releasing compounds, guanidines, sulfones, thiocyanates, pyrithiones, antibiotics such as β-lactam antibiotics, quaternary ammonium salts, peroxides, perchlorates, amides, amines, heavy metals, biocidal enzymes, biocidal polypeptides, azoles, carbamates, glyphosates, sulphonamides and mixtures thereof.

Thus, it is an objective of the present invention to provide a storage stabilization agent that is used for stabilizing an aqueous home care formulation upon storage. In particular, it is an objective of the present invention to provide a storage stabilization agent which prevents or reduces microbial growth in aqueous home care preparations. It is still a further object of the present invention to provide a storage stabilization agent which avoids, or at least reduces, the use of conventional antimicrobials or biocides such as phenols, halogenated phenols, halogen-containing compounds, halogen-releasing compounds, isothiazolinones, aldehyde-containing compounds, aldehyde-releasing compounds, guanidines, sulfones, thiocyanates, pyrithiones, antibiotics such as β-lactam antibiotics, quaternary ammonium salts, peroxides, perchlorates, amides, amines, biocidal enzymes, biocidal polypeptides, azoles, carbamates, glyphosates, sulphonamides and mixtures thereof. Furthermore, it is another objective of the present invention that the storage stabilization agent is easy to handle and transport, cheap, and is not toxic to humans, animals and/or the environment.

### SUMMARY OF THE INVENTION

These and other objectives of the present invention can be solved by a storage stabilization agent for use in an aqueous home care formulation, an aqueous home care formulation comprising the storage stabilization agent, a process and the uses as described in the present invention and defined in the claims.

According to one embodiment, the present invention refers to the use of a storage stabilization agent for stabilizing an aqueous home care formulation upon storage, wherein the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

The inventors surprisingly found that the inventive storage stabilization agent can be used to stabilize an aqueous home care formulation upon storage. More precisely, the storage stabilization agent stabilizes the aqueous home care formulation for a defined amount of time against microorganisms. Furthermore, in addition to the storage stabilization agent no further antimicrobials and/or biocides are necessary to prevent or reduce microbial growth. Furthermore, the inventive storage stabilization agent is easy to handle and transport, cheap, and is not toxic to humans, animals and/or the environment.

A second aspect of the present invention refers to a storage stabilization agent for stabilizing an aqueous home care formulation upon storage, comprising at least two different water soluble or water dispersible ion sources selected from the group consisting of water soluble or water dispersible source of bismuth ions, water soluble or water dispersible source of lithium ions, water dispersible source of magnesium ions and at least on water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

A further aspect refers to an aqueous home care formulation comprising the inventive storage stabilization agent, wherein the aqueous home care formulation is preferably a washing formulation, preferably for cleaning of laundry, fabrics, dishes and hard surfaces; a pre-washing formulation; a rinsing formulation; a bleaching formulation; a laundry fabric-softener formulation; a cleaning formulation; and mixtures thereof.

Another aspect of the present invention refers to a process for stabilizing an aqueous home care formulation upon storage, said process comprises the steps of a) providing an aqueous home care formulation, preferably a washing formulation, preferably for cleaning of laundry, fabrics, dishes and hard surfaces; a pre-washing formulation; a rinsing formulation; a bleaching formulation; a laundry fabric-softener formulation; a cleaning formulation; and mixtures thereof, b) providing a storage stabilization agent according to the present invention, and c) contacting and mixing the aqueous home care formulation of step a) with the storage stabilization agent of step b) in any order for obtaining the stabilized aqueous home care formulation.

Preferred embodiments of the present invention are defined in the dependent claims.

According to one embodiment of the present invention, the water soluble or water dispersible source of bismuth ions is at least one bismuth compound, preferably the at least one bismuth compound is selected from the group consisting of bismuth carbonate, bismuth subcarbonate, bismuth oxide, bismuth hydroxide, bismuth chloride, bismuth iodide, bismuth phosphate, bismuth citrate, bismuth acetate, bismuth lactate, bismuth subsalicylate, polymeric compounds of bismuth and mixtures thereof, said polymeric compounds of bismuth is preferably selected from bismuth compounds of acrylic homopolymers, acrylic copolymers such as copolymers of acrylic acid and maleic acid and/or acrylamide, polyphosphates and mixtures thereof.

According to another embodiment of the present invention, the at least one water soluble or water dispersible source of lithium ions is at least one lithium salt, preferably the at least one lithium salt is selected from lithium carbonate, lithium chloride, lithium hydroxide, lithium phosphate, lithium citrate, lithium maleate, lithium acetate and lithium lactate; polymeric salts of lithium and mixtures thereof, said polymeric salt of lithium is preferably selected from lithium salts of acrylic homopolymers, acrylic copolymers such as copolymers of acrylic acid and maleic acid and/or acrylamide, polyphosphates and mixtures thereof, said polymeric salt of lithium is more preferably Li₂Na₂polyphosphate, lithium-sodium hexametaphosphate or lithium polyacrylate.

According to another embodiment of the present invention, the at least one dispersible source of magnesium ions is a) hydromagnesite, preferably natural or synthetic hydromagnesite, more preferably synthetic hydromagnesite, and most preferably precipitated hydromagnesite and/or b) wherein the water dispersible source of magnesium ions is in form of particles having i) a volume median grain diameter (d₅₀) of ≥150 nm, preferably from 150 nm to 50 μm, more preferably from 0.2 to 25 μm, even more preferably from 0.5 to 20 μm, and most preferably from 1 to 5 μm, as determined by laser diffraction, and/or ii) a volume determined top cut particle size (d₉₈) of equal to or less than 30 μm, preferably from 2 to 30 μm, more preferably from 5 to 20, and most preferably from 8 to 18 μm, as determined by laser diffraction, or c) wherein the water dispersible source of magnesium ions is in form of granules having i) a volume median particle size d₅₀ of from 5 to 300 μm, preferably from 8 to 200 μm, and most preferably from 10 to 150 μm, as determined by laser diffraction, and ii) a volume particle size d₉₀ of from 15 to 500 μm, preferably from 20 to 400 μm, and most preferably from 30 to 250 μm, as determined by laser diffraction and iii) a volume particle size d₁₀ of from 1 to 100 μm, preferably from 2 to 70 μm, and most preferably from 4 to 50 μm, as determined by laser diffraction.

According to another embodiment of the present invention, the alkali carbonate is selected from the group consisting of sodium carbonate, potassium carbonate, lithium carbonate, and mixtures thereof, preferably sodium carbonate and/or lithium carbonate and most preferably sodium carbonate and/or the at least one alkali bicarbonate is selected from the group consisting of sodium bicarbonate, potassium bicarbonate, lithium bicarbonate, and mixtures thereof, preferably sodium bicarbonate and/or lithium bicarbonate and most preferably sodium bicarbonate.

According to another embodiment of the present invention, each of the water soluble or water dispersible sources of ions are present in the composition in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the aqueous home care formulation.

According to another embodiment of the present invention, the weight ratio of the at least two different water soluble or water dispersible ion sources is from 100:1 to 1:100, preferably from 10:1 to 1:10 and most preferably from 5:1 to 1:5.

According to another embodiment of the present invention, the storage stabilization agent comprises further additives selected from the group consisting of dispersing agents, viscosity agents, thickeners, rheological additives and defoaming agents.

According to another embodiment of the present invention, the at least two different water soluble or water dispersible ion sources are a water dispersible source of magnesium ions and at least a water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

According to another preferred embodiment of the present invention, the at least two different water soluble or water dispersible ion sources are a water dispersible source of magnesium ions and at least a water soluble or water dispersible source of alkali ions, wherein the water soluble or water dispersible source of alkali ions is selected from alkali carbonate and/or alkali bicarbonate and preferably is sodium carbonate and wherein the water dispersible source of magnesium ions is selected from magnesium carbonate or magnesite (MgCO₃) and/or hydromagnesite (Mg₅(CO₃)₄(OH)₂·4H₂O), preferably is hydromagnesite (Mg₅(CO₃)₄(OH)₂·4H₂O) even more preferably is synthetically hydromagnesite and most preferably is precipitated hydromagnesite.

According to another embodiment of the present invention, the at least two different water soluble or water dispersible ion sources are a water dispersible source of bismuth ions and at least a water soluble or water dispersible source of alkali ions, wherein the water soluble or water dispersible source of alkali ions is selected from alkali carbonate and/or alkali bicarbonate.

According to another preferred embodiment of the present invention, the at least two different water soluble or water dispersible ion sources are a water dispersible source of bismuth ions and at least a water soluble or water dispersible source of alkali ions, wherein the water soluble or water dispersible source of alkali ions is selected from alkali carbonate and/or alkali bicarbonate and preferably is sodium carbonate and wherein the water dispersible source of bismuth ions is at least one bismuth compound, preferably the at least one bismuth compound is selected from the group consisting of bismuth carbonate, bismuth subcarbonate, bismuth oxide, bismuth hydroxide, bismuth chloride, bismuth iodide, bismuth phosphate, bismuth citrate, bismuth acetate, bismuth lactate, bismuth subsalicylate, polymeric compounds of bismuth and mixtures thereof and most preferably the bismuth compound is bismuth oxide.

According to another embodiment of the present invention, the microorganisms are selected from the group comprising at least one strain of bacteria, at least one strain of fungi, such as mold or yeast, algae and mixtures thereof.

According to another embodiment of the present invention, the storage stabilization agent stabilizes the aqueous home care formulation upon storage, for at least 15 days against microorganisms, wherein the microorganisms are selected from the group comprising at least one strain of bacteria, at least one strain of fungi, such as mold or yeast, algae and mixtures thereof.

According to another embodiment of the present invention, the inventive storage stabilization agent is present in an amount such that the aqueous home care formulation is preserved against microorganisms for at least 15 days, preferably for at least 20 days more preferably for at least 30 days, even more preferably at least 60 days and most preferably at least 90 days.

It should be understood that for the purposes of the present invention, the following terms have the following meanings:

A storage stabilization agent in the meaning of the present invention is an agent that stabilizes an aqueous composition upon storage. By “stabilizing upon storage” it is meant that an aqueous composition is stabilized for a defined amount of time against microorganisms and optionally against pH change. More precisely, by stabilizing upon storage it is meant that an aqueous composition, stored motionless at 25° C., does prevent or reduce the growth and/or reproduction of microorganisms for at least 15 days and optionally does not exhibit a change in the pH value of more than +/−1 for at least 15 days.

According to the present invention, the wording “prevents microbial growth” means that no significant growth of microorganisms such as at least one strain of bacteria, at least one strain of fungi, such as mold or yeast, algae and mixtures thereof is observed in the aqueous home care formulation when the storage stabilization agent is present. This preferably does not lead to an increase of the cfu value in the treated aqueous home care formulation compared to the home care formulation immediately before treatment, more preferably to a decrease of the value to less than 100 cfu/1 ml or 1 g of the aqueous home care formulation, using the bacterial count method described in the example section herein. It is appreciated that the final aqueous home care formulation, i.e. comprising the storage stabilization agent, is diluted by a factor of 10 and 100 μl of the diluted composition is then plated out in order to evaluate the microbial growth.

According to the present invention, the wording “reduce microbial growth” means that growth of microorganisms such as at least one strain of bacteria, at least one strain of fungi, such as mold or yeast, algae and mixtures thereof is slower in the aqueous preparation when the storage stabilization agent is present. This preferably leads to a lower cfu value in the treated aqueous home care formulation compared to the home care formulation without the storage stabilization agent before treatment, more preferably to a value of less than 100 cfu/1 ml or 1 g of the aqueous home care formulation, using the bacterial count method described in the example section herein. It is appreciated that the final aqueous home care formulation, i.e. comprising the storage stabilization agent, is diluted by a factor of 10 and 100 μl of the diluted composition is then plated out in order to evaluate the microbial growth.

The term “microorganisms” or “microbe” in the meaning of the present invention refers to organisms of microscopic size and especially to bacteria, fungi, such as mold or yeast, algae and mixtures thereof.

For the purpose of the present application, “water-insoluble” or “water-dispersible” materials are defined as those which, when mixed with 100 ml of deionised water and filtered at 20° C. to recover the liquid filtrate, provide less than or equal to 0.1 g of recovered solid material following evaporation at 95 to 100° C. of 100 g of said liquid filtrate. “Water-soluble” materials are defined as materials leading to the recovery of greater than 0.1 g of solid material following evaporation at 95 to 100° C. of 100 g of said liquid filtrate. In order to assess whether a material is an insoluble or soluble material in the meaning of the present invention, the sample size is greater than 0.1 g, preferably 0.5 g or more.

For the purpose of the present invention, the term “viscosity” or “Brookfield viscosity” refers to Brookfield viscosity. The Brookfield viscosity is for this purpose measured by a Brookfield DV-II+ Pro viscometer at 25° C.±1° C. at 100 rpm using an appropriate spindle of the Brookfield RV-spindle set and is specified in mPa·s. Based on his technical knowledge, the skilled person will select a spindle from the Brookfield RV-spindle set which is suitable for the viscosity range to be measured. For example, for a viscosity range between 200 and 800 mPa·s the spindle number 3 may be used, for a viscosity range between 400 and 1 600 mPa·s the spindle number 4 may be used, for a viscosity range between 800 and 3 200 mPa·s the spindle number 5 may be used, for a viscosity range between 1 000 and 2 000 000 mPa·s the spindle number 6 may be used, and for a viscosity range between 4 000 and 8 000 000 mPa·s the spindle number 7 may be used.

Throughout the present document, the “particle size” of magnesium ion particles or granules is described by its distribution of particle sizes dₓ(vol) on a volume base. Therein, the value dₓ(vol) represents the diameter relative to which x % by volume of the particles have diameters less than dₓ(vol). This means that, for example, the d₂₀(vol) value is the particle size at which 20 vol. % of all particles are smaller than that particle size. The d₅₀(vol) value is thus the volume median particle size, i.e. 50 vol. % of all particles are smaller than that particle size and the d₉₈(vol) value, referred to as volume-based top cut, is the particle size at which 98 vol. % of all particles are smaller than that particle size. Volume determined median grain diameter d₅₀ (or d₅₀(vol)) and the volume determined top cut particle size d₉₈ (or d₉₈(vol)) was evaluated using a Malvern Mastersizer 3000 Laser Diffraction System (Malvern Instruments Plc., Great Britain) equipped with a Hydro LV system. The d₅₀(vol) or d₉₈(vol) value indicates a diameter value such that 50% or 98% by volume, respectively, of the particles have a diameter of less than this value. The powders were suspended in 0.1 wt.-% Na₄O₇P₂ solution. 10 mL of 0.1 wt.-% Na₄O₇P₂ was added to the Hydro LV tank, then the sample slurry was introduced until an obscuration between 10-20% was achieved. Measurements were conducted with red and blue light for 10 s each. For the analysis of the raw data, the models for non-spherical particle sizes using Mie theory was utilized, and a particle refractive index of 1.57, a density of 2.70 g/cm³, and an absorption index of 0.005 was assumed. The methods and instruments are known to the skilled person and are commonly used to determine particle size distributions of fillers and pigments.

Throughout the present document, the term “specific surface area” (in m²/g), which is used to define magnesium ion particles or granules like hydromagnesite or other materials, refers to the specific surface area as determined by using the BET method (using nitrogen as absorbing gas). Throughout the present document, the specific surface area (in m²/g) is determined using the BET method (using nitrogen as absorbing gas), which is well known to the skilled man (ISO 9277:2010). The total surface area (in m²) of the filler material is then obtained by multiplication of the specific surface area and the mass (in g) of the corresponding sample.

For the purpose of the present invention, the “solids content” of a liquid composition is a measure of the amount of material remaining after all the solvent or water has been evaporated. If necessary, the “solids content” of a suspension given in wt. % in the meaning of the present invention can be determined using a Moisture Analyzer HR73 from Mettler-Toledo (T=120° C., automatic switch off 3, standard drying) with a sample size of 5 to 20 g.

A “suspension” or “slurry” in the meaning of the present invention comprises undissolved solids and water, and optionally further additives, and usually contains large amounts of solids and, thus, is more viscous and can be of higher density than the liquid from which it is formed.

An “aqueous composition” and an “aqueous home care formulation” in the meaning of the present invention refers to a composition and a home care formulation comprising water. More precisely, the term “aqueous” composition/home care formulation refers to a system, wherein the liquid phase comprises, preferably consists of, water. However, said term does not exclude that the liquid phase of the aqueous composition/home care formulation comprises minor amounts of at least one water-miscible organic solvent, preferably selected from the group comprising methanol, ethanol, acetone, acetonitrile, tetrahydrofuran and mixtures thereof. If the aqueous composition/home care formulation comprises at least one water-miscible organic solvent, the liquid phase of the aqueous composition/home care formulation comprises the at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase of the aqueous composition/home care formulation. For example, the liquid phase of the aqueous composition/home care formulation consists of water.

A “home care formulation” in the meaning of the present invention is a formulation that is used in the home care sector for cleaning and washing, and is preferably a washing formulation, preferably for cleaning of laundry, fabrics, dishes and hard surfaces; a pre-washing formulation; a rinsing formulation; a bleaching formulation; a laundry fabric-softener formulation; a cleaning formulation; and mixtures thereof.

A “salt” in the meaning of the present invention is a chemical compound consisting of an ionic assembly of cations (positively charged ions) and anions (negatively charged ions) so that the product is electrically neutral (without a net charge).

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

### DETAILED DESCRIPTION OF THE INVENTION

According to the present invention a storage stabilization agent is used for stabilizing an aqueous home care formulation upon storage, wherein the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

In the following preferred embodiments of the inventive storage stabilization agent that is used for stabilizing an aqueous home care formulation upon storage will be set out in more detail. It is to be understood that these embodiments and details also apply to the inventive aqueous home care formulation and uses thereof, as well as to the inventive process for stabilizing that aqueous home care formulation.

The Storage Stabilization Agent that is Used for Stabilizing an Aqueous Home Care Formulation Upon Storage

According to the present invention a storage stabilization agent is used for stabilizing an aqueous home care formulation upon storage. The storage stabilization agent for stabilizing an aqueous home care formulation upon storage, that is used in the present invention, comprises at least two different water soluble or water dispersible ion sources selected from the group consisting of water soluble or water dispersible source of bismuth ions, water soluble or water dispersible source of lithium ions, water dispersible source of magnesium ions and at least on water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

Thus, it is one requirement of the present storage stabilization agent that is used in the present invention, that it comprises at least two different water soluble or water dispersible ion sources selected from the group consisting of water soluble or water dispersible source of bismuth ions, water soluble or water dispersible source of lithium ions, water dispersible source of magnesium ions and at least on water soluble or water dispersible source of alkali ions.

“At least two different” in the meaning of the present invention means that two or more, for example, three or all four water soluble or water dispersible ion sources are present in the inventive storage stabilization agent. “Different” in the meaning of the present invention means that, if the storage stabilization agent for stabilizing an aqueous home care formulation upon storage comprises at least one water soluble or water dispersible source of bismuth ions as one water soluble or water dispersible ion source, the second water soluble or water dispersible ion source is selected from the group of consisting of water soluble or water dispersible source of lithium ions, water dispersible source of magnesium ions and at least on water soluble or water dispersible source of alkali ions. Alternatively, if the storage stabilization agent for stabilizing an aqueous home care formulation upon storage comprises at least one water soluble or water dispersible source of lithium ions as one water soluble or water dispersible ion source, the second water soluble or water dispersible ion source is selected from the group consisting of water soluble or water dispersible source of bismuth ions, water dispersible source of magnesium ions and at least on water soluble or water dispersible source of alkali ions.

Alternatively, if the storage stabilization agent for stabilizing an aqueous home care formulation upon storage comprises at least one water dispersible source of magnesium ions as one water soluble or water dispersible ion source, the second water soluble or water dispersible ion source is selected from the group of consisting of water soluble or water dispersible source of bismuth ions, water dispersible source of lithium ions and at least on water soluble or water dispersible source of alkali ions.

Finally, if the storage stabilization agent for stabilizing an aqueous home care formulation upon storage comprises at least one water soluble or water dispersible source of alkali ions as one water soluble or water dispersible ion source, the second water soluble or water dispersible ion source is selected from the group of consisting of water soluble or water dispersible source of bismuth ions, water dispersible source of lithium ions and at least on water soluble or water dispersible source of magnesium ions.

The term source of water soluble or water dispersible source of bismuth ions in the meaning of the present invention means that the source comprises, preferably consists of, one or more water soluble or water dispersible source(s) of bismuth ions.

In one embodiment of the present invention, the water soluble or water dispersible source of bismuth ions comprises, preferably consists of, one water soluble or water dispersible source of bismuth ions. Alternatively, the water soluble or water dispersible source of bismuth ions comprises, preferably consists of, two or more water soluble or water dispersible sources of bismuth ions. For example, the water soluble or water dispersible source of bismuth ions comprises, preferably consists of, two or three water soluble or water dispersible sources of bismuth ions. Preferably, the water soluble or water dispersible source of bismuth ions comprises, preferably consists of, two or more water soluble or water dispersible sources of bismuth ions.

It is appreciated that the at least one water soluble or water dispersible source of bismuth ions of the storage stabilization agent can be any material comprising, preferably consisting of, bismuth ions as cations.

The at least one source of bismuth ions is water soluble or water dispersible. The term “water-insoluble” or “water-dispersible” or “dispersible in water” in the meaning of the present invention refers to systems in which only a part of the source of bismuth ions forms a solution with water, i.e. only a part of the particles of the at least one source of bismuth ions are dissolved in the solvent. More precisely, when the at least one source of bismuth ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate. The term “water soluble” or “soluble in water” in the meaning of the present invention refers to systems in which the source of bismuth ions forms a solution with water, i.e. the particles of the at least one source of bismuth ions are dissolved in the solvent. More precisely, when the at least one source of bismuth ions is mixed with 100 ml of deionised water and filtered at 20° C. to recover the liquid filtrate the liquid filtrate provides more than 0.1 g of recovered solid material following evaporation at 95 to 100° C. of 100 g of said liquid filtrate. In order to assess whether a source of bismuth ions is an insoluble or soluble material in the meaning of the present invention, the sample size is greater than 0.1 g, preferably 0.5 g or more.

The term “source” of bismuth ions in the meaning of the present invention refers to a compound that comprises, preferably consists of, bismuth ions, i.e. bismuth cations.

In one embodiment of the present invention, the water soluble or water dispersible source of bismuth ions is provided in the form of at least one bismuth compound. Preferably, the counter group of the at least one bismuth compound is selected from the group comprising carbonate, oxide, chloride, hydroxide, iodide, phosphate, citrate, acetate, lactate, salicylate and mixtures thereof. In particular, the at least one bismuth compound is selected from the group consisting of bismuth carbonate, bismuth subcarbonate, bismuth oxide, bismuth hydroxide, bismuth chloride, bismuth iodide, bismuth phosphate, bismuth citrate, bismuth acetate, bismuth lactate, bismuth subsalicylate, polymeric compounds of bismuth and mixtures thereof.

According to a preferred embodiment, the water soluble or water dispersible source of bismuth ions is preferably bismuth carbonate, bismuth oxide or bismuth hydroxide. Preferably, the water soluble or water dispersible source of bismuth ions is bismuth oxide.

Additionally or alternatively, the water soluble or water dispersible source of bismuth ions is present as a polymeric compound of bismuth, such as acrylic homopolymers or acrylic copolymers. The polymeric salt of bismuth is preferably bismuth polyacrylate. The polymeric compound of bismuth can be partially or completely neutralized, using a neutralizing agent containing ions of bismuth and, optionally other alkali metals and/or alkaline earth metals. Neutralized polyacrylates and/or polymethacrylates with an average molecular weight of not more than 50 000 are especially suitable.

Such sources of bismuth ions are known to the skilled person and are commercially available.

The term source of water soluble or water dispersible lithium ions in the meaning of the present invention means that the source comprises, preferably consists of, one or more water soluble or water dispersible source(s) of lithium ions.

In one embodiment of the present invention, the water soluble or water dispersible source of lithium ions comprises, preferably consists of, one water soluble or water dispersible source of lithium ions. Alternatively, the water soluble or water dispersible source of lithium ions comprises, preferably consists of, two or more water soluble or water dispersible sources of lithium ions. For example, the water soluble or water dispersible source of lithium ions comprises, preferably consists of, two or three water soluble or water dispersible sources of lithium ions. Preferably, the water soluble or water dispersible source of lithium ions comprises, preferably consists of, two or more water soluble or water dispersible sources of lithium ions.

It is appreciated that the at least one water soluble or water dispersible source of lithium ions of the instant storage stabilization agent can be any material comprising, preferably consisting of, lithium ions as cations.

According to a preferred embodiment the at least one source of lithium ions is water soluble or water dispersible.

The at least one source of lithium ions is water soluble or water dispersible. The term “water-insoluble” or “water-dispersible” or “dispersible in water” in the meaning of the present invention refers to systems in which only a part of the source of lithium ions forms a solution with water, i.e. only a part of the particles of the at least one source of lithium ions are dissolved in the solvent. More precisely, when the at least one source of lithium ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate. The term “water soluble” or “soluble in water” in the meaning of the present invention refers to systems in which the source of lithium ions forms a solution with water, i.e. the particles of the at least one source of lithium ions are dissolved in the solvent. More precisely, when the at least one source of lithium ions is mixed with 100 ml of deionised water and filtered at 20° C. to recover the liquid filtrate the liquid filtrate provides more than 0.1 g of recovered solid material following evaporation at 95 to 100° C. of 100 g of said liquid filtrate. In order to assess whether a source of lithium ions is an insoluble or soluble material in the meaning of the present invention, the sample size is greater than 0.1 g, preferably 0.5 g or more.

The term “source” of lithium ions in the meaning of the present invention refers to a compound that comprises, preferably consists of, lithium ions, i.e. lithium cations.

In one embodiment of the present invention, the water soluble or water dispersible source of lithium ions is preferably provided in the form of at least one lithium salt. Preferably the anionic group of the at least one lithium salt is selected from the group comprising carbonate, chloride, hydroxide, phosphate, citrate, maleate, acetate, lactate and mixtures thereof. In particular, the at least one lithium salt is selected from the group consisting of lithium carbonate, lithium chloride, lithium hydroxide, lithium phosphate, lithium citrate, lithium maleate, lithium acetate and lithium lactate, polymeric salts of lithium and mixtures thereof.

According to a preferred embodiment, the at least one water soluble or water dispersible source of lithium ions is preferably lithium carbonate.

Additionally or alternatively, the water soluble or water dispersible source of lithium ions is present as a polymeric salt of lithium, such as acrylic homopolymers, acrylic copolymers such as copolymers of acrylic acid and maleic acid and/or acrylamide, polyphosphates and mixtures thereof having multiple acidic sites which can be partially or totally neutralised with lithium ions. The polymeric salt of lithium is preferably selected from Li₂Na₂polyphosphate, lithium-sodium hexametaphosphate or lithium polyacrylate.

The polymeric salt of lithium is preferably partially or completely neutralized, preferably to a degree of 5.0 to 100.0%, preferably to a degree of 25.0 to 100.0% and most preferably to a degree of 75.0 to 100.0% using a neutralizing agent containing ions of lithium and, optionally other alkali metals and/or alkaline earth metals. In one embodiment, the acidic sites of the polymeric salt of lithium are neutralized using a neutralizing agent containing only lithium. Neutralized polyacrylates and/or polymethacrylates with an average molecular weight of not more than 50 000, preferably with an average molecular weight in the range from 1 000 to 25 000 and more preferably in the range from 3 000 to 12 000 are especially suitable.

Such sources of lithium ions are known to the skilled person and are commercially available.

Furthermore, it is one requirement of the present invention that the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions. In case one water soluble or water dispersible ion source is a water soluble or water dispersible source of lithium ions, then the second water soluble or water dispersible ion source is preferably selected from water soluble or water dispersible source of bismuth ions or water soluble or water dispersible source of magnesium ions. In case the second water soluble or water dispersible ion source is at least a water soluble or water dispersible source of alkali ions, then it does not consist of lithium carbonate and/or lithium bicarbonate but consist or comprises at least one alkali carbonate and/or alkali bicarbonate that is different to lithium carbonate and/or lithium bicarbonate. However, it is still possible that lithium carbonate and/or lithium bicarbonate is present in the stabilization agent in addition to the water soluble or water dispersible source of alkali ions that is different to lithium carbonate and/or lithium bicarbonate.

According to a preferred embodiment of the present invention, a storage stabilization agent is used for stabilizing an aqueous home care formulation upon storage, wherein the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions,
wherein the water soluble or water dispersible source of alkali ions is selected from alkali carbonate and/or alkali bicarbonate and
wherein the water dispersible source of magnesium ions is selected from magnesium carbonate or magnesite (MgCO₃) and/or hydromagnesite (Mg₅(CO₃)₄(OH)₂·4H₂O),
with the proviso that if the first water soluble or water dispersible ion source is a water soluble or water dispersible source of lithium ions, then the second water soluble or water dispersible ion source is selected from water soluble or water dispersible source of bismuth ions or water soluble or water dispersible source of magnesium ions.

According to another preferred embodiment of the present invention, a storage stabilization agent is used for stabilizing an aqueous home care formulation upon storage, wherein the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions,
wherein the water soluble or water dispersible source of alkali ions is selected from alkali carbonate and/or alkali bicarbonate and
wherein the water dispersible source of magnesium ions is hydromagnesite (Mg₅(CO₃)₄(OH)₂·4H₂O),
with the proviso that if the first water soluble or water dispersible ion source is a water soluble or water dispersible source of lithium ions, then the second water soluble or water dispersible ion source is selected from water soluble or water dispersible source of bismuth ions or water soluble or water dispersible source of magnesium ions.

The term source of water dispersible magnesium ions in the meaning of the present invention means that the source comprises, preferably consists of, one or more water dispersible source(s) of magnesium ions.

In one embodiment of the present invention, the water dispersible source of magnesium ions comprises, preferably consists of, one water dispersible source of magnesium ions. Alternatively, the water dispersible source of magnesium ions comprises, preferably consists of, two or more water dispersible sources of magnesium ions. For example, the water dispersible source of magnesium ions comprises, preferably consists of, two or three water dispersible sources of magnesium ions. Preferably, the water dispersible source of magnesium ions comprises, preferably consists of, two or more water dispersible sources of magnesium ions.

The source of magnesium ions is water dispersible. The term “water-insoluble” or “water-dispersible” or “dispersible in water” in the meaning of the present invention refers to systems in which only a part of the source of magnesium ions forms a solution with water, i.e. only a part of the particles of the at least one source of magnesium ions are dissolved in the solvent. More precisely, when the at least one source of magnesium ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate.

It is one requirement of the present invention that the water dispersible source of magnesium ions is selected from magnesium carbonate or magnesite (MgCO₃) and/or hydromagnesite (Mg₅(CO₃)₄(OH)₂·4H₂O).

The water dispersible source of magnesium ions can be a naturally occurring or synthetic water dispersible source of magnesium ions.

According to one embodiment of the present invention the water dispersible source of magnesium ions is a naturally occurring water dispersible source of magnesium ions, namely naturally occurring magnesium carbonate or magnesite (MgCO₃) and/or hydromagnesite (Mg₅(CO₃)₄(OH)₂·4H₂O). According to a preferred embodiment of the present invention, the water dispersible source of magnesium ions is hydromagnesite (Mg₅(CO₃)₄(OH)₂·4H₂O)

According to one embodiment of the present invention the naturally occurring water dispersible source of magnesium ions may be obtained by dry grinding. According to another embodiment of the present invention, the naturally occurring water dispersible source of magnesium ions may be obtained by wet grinding and optionally subsequent drying.

In general, the grinding step can be carried out with any conventional grinding device, for example, under conditions such that comminution predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled man. In case the water dispersible source of magnesium ions is obtained by wet-grinding, the grinding step may be performed under conditions such that autogenous grinding takes place and/or by horizontal ball milling, and/or other such processes known to the skilled man. The wet processed ground water dispersible source of magnesium ions thus obtained may be washed and dewatered by well-known processes, e.g. by flocculation, filtration or forced evaporation prior to drying. The subsequent step of drying may be carried out in a single step such as spray drying, or in at least two steps. It is also common that such a mineral material undergoes a beneficiation step (such as a flotation, bleaching or magnetic separation step) to remove impurities.

According to one embodiment of the present invention the water dispersible source of magnesium ions is a synthetic water dispersible source of magnesium ions, namely synthetic magnesium carbonate or magnesite (MgCO₃) and/or hydromagnesite (Mg₅(CO₃)₄(OH)₂·4H₂O).

Synthetic water dispersible source of magnesium ions in the meaning of the present invention can be obtained by processes well known in the art. For example, U.S. Pat. Nos. 1,361,324, 935,418, GB548197 and GB544907 generally describe the formation of aqueous solutions of magnesium bicarbonate (typically described as “Mg(HCO₃)₂”), which is then transformed by the action of a base, e.g., magnesium hydroxide, to form hydromagnesite. Other processes described in the art suggest to prepare compositions containing both, hydromagnesite and magnesium hydroxide, wherein magnesium hydroxide is mixed with water to form a suspension which is further contacted with carbon dioxide and an aqueous basic solution to form the corresponding mixture; cf. for example U.S. Pat. No. 5,979,461. EP0526121 describes a calcium-magnesium carbonate composite consisting of calcium carbonate and magnesium carbonate hydroxide and a method for the preparation thereof. Furthermore, GB594262 relates to a method and apparatus for treating magnesia-containing materials, such as magnesium and calcium carbonate materials for obtaining respective carbonates in discrete and separate forms, by controlled carbonation such that the magnesium and calcium carbonates may be separated by mechanical means and with attainment of special utilities in separated products. US2007194276 describes a method of reductively bleaching a mineral slurry comprising adding in the mineral slurry an effective amount of a formamidine sulfinic acid (FAS) and an effective amount of a borohydride to reductively bleach the mineral slurry.

In one embodiment, the water dispersible source of magnesium ions is magnesium carbonate or magnesite (MgCO₃), preferably naturally occurring magnesium carbonate or magnesite (MgCO₃). Naturally occurring magnesium carbonate or magnesite (MgCO₃) is known to the skilled person and is commercially available.

According to another embodiment, the water dispersible source of magnesium ions is hydromagnesite (Mg₅(CO₃)₄(OH)₂·4H₂O), preferably natural or synthetic hydromagnesite, more preferably synthetic hydromagnesite, and most preferably precipitated hydromagnesite (PHM). Hydromagnesite (Mg₅(CO₃)₄(OH)₂·4H₂O) such as precipitated hydromagnesite is known to the skilled person and is commercially available. Furthermore, the preparation of precipitated hydromagnesite is known to the skilled person, for example from WO2011054831.

According to another embodiment, the water dispersible source of magnesium ions is a mixture of magnesium carbonate or magnesite (MgCO₃), preferably naturally occurring magnesium carbonate or magnesite (MgCO₃) and hydromagnesite (Mg₅(CO₃)₄(OH)₂·4H₂O), preferably synthetically hydromagnesite (Mg₅(CO₃)₄(OH)₂·4H₂O).

According to one embodiment of the present invention, the water dispersible source of magnesium ions is in form of particles having a volume median grain diameter (d₅₀) of ≥150 nm, preferably from 150 nm to 50 μm, more preferably from 0.2 to 25 μm, even more preferably from 0.5 to 20 μm, and most preferably from 1 to 5 μm, as determined by laser diffraction.

Additionally or alternatively, the water dispersible source of magnesium ions is in form of particles having a volume determined top cut particle size (d₉₈) of equal to or less than 30 μm, preferably from 2 to 30 μm, more preferably from 5 to 20, and most preferably from 8 to 18 μm, as determined by laser diffraction.

According to one embodiment of the present invention, the water dispersible source of magnesium ions is in form of particles having a volume median grain diameter (d₅₀) of ≥150 nm, preferably from 150 nm to 50 μm, more preferably from 0.2 to 25 μm, even more preferably from 0.5 to 20 μm, and most preferably from 1 to 5 μm, as determined by laser diffraction and a volume determined top cut particle size (d₉₈) of equal to or less than 30 μm, preferably from 2 to 30 μm, more preferably from 5 to 20, and most preferably from 8 to 18 μm, as determined by laser diffraction.

According to another embodiment of the present invention, the water dispersible source of magnesium ions is in form of particles having a volume median grain diameter (d₅₀) of ≥150 nm, preferably from 150 nm to 50 μm, more preferably from 0.2 to 25 μm, even more preferably from 0.5 to 20 μm, and most preferably from 1 to 5 μm, as determined by laser diffraction or a volume determined top cut particle size (d₉₈) of equal to or less than 30 μm, preferably from 2 to 30 μm, more preferably from 5 to 20, and most preferably from 8 to 18 μm, as determined by laser diffraction.

According to another embodiment of the present invention, the water dispersible source of magnesium ions is magnesium carbonate or magnesite (MgCO₃), preferably naturally occurring magnesium carbonate or magnesite (MgCO₃) and/or hydromagnesite (Mg₅(CO₃)₄(OH)₂·4H₂O), preferably synthetically hydromagnesite (Mg₅(CO₃)₄(OH)₂·4H₂O) and most preferably precipitated hydromagnesite (PHM) and is in form of particles having a volume median grain diameter (d₅₀) of ≥150 nm, preferably from 150 nm to 50 μm, more preferably from 0.2 to 25 μm, even more preferably from 0.5 to 20 μm, and most preferably from 1 to 5 μm, as determined by laser diffraction and/or a volume determined top cut particle size (d₉₈) of equal to or less than 30 μm, preferably from 2 to 30 μm, more preferably from 5 to 20, and most preferably from 8 to 18 μm, as determined by laser diffraction.

According to one embodiment of the present invention, the water dispersible source of magnesium ions is in form of granules having a volume median particle size d₅₀ of from 5 to 300 μm, preferably from 8 to 200 μm, and most preferably from 10 to 150 μm, as determined by laser diffraction and a volume particle size d₉₀ of from 15 to 500 μm, preferably from 20 to 400 μm, and most preferably from 30 to 250 μm, as determined by laser diffraction and a volume particle size d₁₀ of from 1 to 100 μm, preferably from 2 to 70 μm, and most preferably from 4 to 50 μm, as determined by laser diffraction.

According to another embodiment of the present invention, the water dispersible source of magnesium ions is magnesium carbonate or magnesite (MgCO₃), preferably naturally occurring magnesium carbonate or magnesite (MgCO₃) and/or hydromagnesite (Mg₅(CO₃)₄(OH)₂·4H₂O), preferably synthetically hydromagnesite (Mg₅(CO₃)₄(OH)₂·4H₂O) and is in form of granules having a volume median particle size d₅₀ of from 5 to 300 μm, preferably from 8 to 200 μm, and most preferably from 10 to 150 μm, as determined by laser diffraction and a volume particle size d₉₀ of from 15 to 500 μm, preferably from 20 to 400 μm, and most preferably from 30 to 250 μm, as determined by laser diffraction and a volume particle size d₁₀ of from 1 to 100 μm, preferably from 2 to 70 μm, and most preferably from 4 to 50 μm, as determined by laser diffraction.

Granules and granulation, i.e. the process in which the primary powder particles are made to adhere or agglomerate to form larger, multiparticle entities is a process of collecting particles together by creating bonds between them e.g. by a binding agent is known to the skilled person. Therefore, a granule is fairly solid agglomeration of finer materials into a larger product such that said product may be strewn or flow about easily without dust issues and with increased reactivity or disintegratability. Such granulation methods are, for example described in EP3733785 A1, EP3517502 A1 and in the unpublished patent application EP21193840.2. For example, granules can be obtained by a) providing an aqueous suspension comprising a magnesium ion-comprising material; b) homogenizing the aqueous suspension comprising a magnesium ion-comprising material of step a), and c) removing the liquid from the aqueous suspension comprising a magnesium ion-comprising material of step b) by means of spray drying for obtaining granules comprising a magnesium ion-comprising material.

Volume determined median grain diameter d₅₀ (or d₅₀(vol)) and the volume determined top cut particle size d₉₈ (or d₉₈(vol)) was evaluated using a Malvern Mastersizer 3000 Laser Diffraction System (Malvern Instruments Plc., Great Britain) equipped with a Hydro LV system. The d₅₀(vol) or d₉₈(vol) value indicates a diameter value such that 50% or 98% by volume, respectively, of the particles have a diameter of less than this value. The powders were suspended in 0.1 wt.-% Na₄O₇P₂ solution. 10 mL of 0.1 wt.-% Na₄O₇P₂ was added to the Hydro LV tank, then the sample slurry was introduced until an obscuration between 10-20% was achieved. Measurements were conducted with red and blue light for 10 s each. For the analysis of the raw data, the models for non-spherical particle sizes using Mie theory was utilized, and a particle refractive index of 1.57, a density of 2.70 g/cm³, and an absorption index of 0.005 was assumed. The methods and instruments are known to the skilled person and are commonly used to determine particle size distributions of fillers and pigments.

In one embodiment, the water dispersible source of magnesium ions is in form of particles or granules having a BET specific surface area in the range from 2 to 200 m²/g, preferably from 10 to 100 m²/g, and most preferably from 12 to 75 m²/g, for example about 55 m²/g measured using nitrogen and the BET method according to ISO 9277:2010.

The “specific surface area” (expressed in m²/g) of a material as used throughout the present application can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 150° C. under vacuum for a period of 60 min prior to measurement.

Such sources of magnesium ions are known to the skilled person and are commercially available.

The term source of water soluble or water dispersible source of alkali ions in the meaning of the present invention means that the source comprises, preferably consists of, one or more water soluble or water dispersible source(s) of alkali ions. It is one requirement that the water soluble or water dispersible source of alkali ions is selected from alkali carbonate and/or alkali bicarbonate.

The alkali carbonate in the meaning of the present invention comprises, preferably consists of, one or more alkali carbonate(s). In one embodiment of the present invention, the alkali carbonate comprises, preferably consists of, one alkali carbonate. Alternatively, the alkali carbonate comprises, preferably consists of, two or more alkali carbonates. For example, the alkali carbonate comprises, preferably consists of, two or three alkali carbonates. Preferably, the alkali carbonate comprises, preferably consists of, one alkali carbonate.

The alkali bicarbonate in the meaning of the present invention means that the alkali bicarbonate comprises, preferably consists of, one or more alkali bicarbonate(s).

In one embodiment of the present invention, the alkali bicarbonate comprises, preferably consists of, one alkali bicarbonate. Alternatively, the alkali bicarbonate comprises, preferably consists of, two or more alkali bicarbonates. For example, the alkali bicarbonate comprises, preferably consists of, two or three alkali bicarbonates. Preferably, the alkali bicarbonate comprises, preferably consists of, one alkali bicarbonate.

It is appreciated that the water soluble or water dispersible source of alkali ions can be any material comprising, preferably consisting of, alkali carbonate and/or alkali bicarbonate.

For example, the water soluble or water dispersible source of alkali ions is at least one alkali carbonate and at least one alkali bicarbonate, i.e. a mixture of the at least one alkali carbonate and at least one alkali bicarbonate. Alternatively, the water soluble or water dispersible source of alkali ions is at least one alkali carbonate or at least one alkali bicarbonate.

In one embodiment, the alkali carbonate is selected from the group consisting of sodium carbonate, potassium carbonate, lithium carbonate, and mixtures thereof. Preferably, the at least one alkali carbonate is selected from the group consisting of sodium carbonate and/or lithium carbonate. More preferably, the at least one alkali carbonate is sodium carbonate.

Additionally or alternatively, the alkali bicarbonate is selected from the group consisting of sodium bicarbonate, potassium bicarbonate, lithium bicarbonate, and mixtures thereof. Preferably, the alkali bicarbonate is selected from the group consisting of sodium bicarbonate and/or lithium bicarbonate. More preferably, the alkali bicarbonate is sodium bicarbonate.

In one embodiment, the water soluble or water dispersible source of alkali ions is a mixture of at least one alkali carbonate and at least one alkali bicarbonate. For example, the water soluble or water dispersible source of alkali ions is a mixture of sodium carbonate and sodium bicarbonate, or a mixture of potassium carbonate and potassium bicarbonate, or a mixture of lithium carbonate and lithium bicarbonate. Preferably, the water soluble or water dispersible source of alkali ions is a mixture of sodium carbonate and sodium bicarbonate or a mixture of lithium carbonate and lithium bicarbonate. More preferably, the water soluble or water dispersible source of alkali ions is a mixture of sodium carbonate and sodium bicarbonate.

In case the water soluble or water dispersible source of alkali ions is a mixture of at least one alkali carbonate and at least one alkali bicarbonate, the alkali carbonate and alkali bicarbonate can be present in any ratio. For example, the molar ratio of the alkali carbonate to the alkali bicarbonate is from 1 000:1 to 1:1 000, preferably from 100:1 to 1:100, more preferably from 20:1 to 1:20, even more preferably from 10:1 to 1:10 and most preferably from 2:1 to 1:2, e.g. about 1:1.

Furthermore, it is one requirement of the present invention that the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions. In case the water soluble or water dispersible source of alkali ions comprises or consists of lithium carbonate and/or lithium bicarbonate, then the second water soluble or water dispersible ion source is selected from water soluble or water dispersible source of bismuth ions or water soluble or water dispersible source of magnesium ions. However, it is still possible that a water soluble or water dispersible source of lithium ions is present in the stabilization agent in addition to the water soluble or water dispersible source of alkali ions that comprises or consists of lithium carbonate and/or lithium bicarbonate, and the second water soluble or water dispersible ion source selected from water soluble or water dispersible source of bismuth ions or water soluble or water dispersible source of magnesium ions. However, according to a preferred embodiment of the present invention, in case the water soluble or water dispersible source of alkali ions comprises or consists of lithium carbonate and/or lithium bicarbonate, then the second water soluble or water dispersible ion source is selected from water soluble or water dispersible source of bismuth ions or water soluble or water dispersible source of magnesium ions and does not comprise further water soluble or water dispersible source of alkali ions and lithium ions. The storage stabilization agent that is used for stabilizing an aqueous home care formulation upon storage does not comprise or consist of lithium carbonate and/or lithium bicarbonate in combination with sodium carbonate and/or sodium bicarbonate.

The storage stabilization agent that is used for stabilizing an aqueous home care formulation upon storage comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

According to a preferred embodiment of the present invention, the storage stabilization agent that is used for stabilizing an aqueous home care formulation upon storage comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions,
wherein the water soluble or water dispersible source of alkali ions is selected from alkali carbonate and/or alkali bicarbonate and
wherein the water dispersible source of magnesium ions is hydromagnesite (Mg₅(CO₃)₄(OH)₂·4H₂O)

In case the storage stabilization agent that is used for stabilizing an aqueous home care formulation upon storage comprises or consists of two different water soluble or water dispersible ion sources, the storage stabilization agent might comprise, or consist of, water soluble or water dispersible source of bismuth ions and water soluble or water dispersible source of lithium ions or water soluble or water dispersible source of bismuth ions and water dispersible source of magnesium ions wherein the water dispersible source of magnesium ions is selected from magnesium carbonate or magnesite (MgCO₃) and/or hydromagnesite (Mg₅(CO₃)₄(OH)₂·4H₂O), or water soluble or water dispersible source of bismuth ions and at least a water soluble or water dispersible source of alkali ions wherein the water soluble or water dispersible source of alkali ions is selected from alkali carbonate and/or alkali bicarbonate, or water soluble or water dispersible source of lithium ions and water dispersible source of magnesium ions wherein the water dispersible source of magnesium ions is selected from magnesium carbonate or magnesite (MgCO₃) and/or hydromagnesite (Mg₅(CO₃)₄(OH)₂·4H₂O), or water soluble or water dispersible source of lithium ions and at least a water soluble or water dispersible source of alkali ions wherein the water soluble or water dispersible source of alkali ions is selected from alkali carbonate and/or alkali bicarbonate, or water dispersible source of magnesium ions wherein the water dispersible source of magnesium ions is selected from magnesium carbonate or magnesite (MgCO₃) and/or hydromagnesite (Mg₅(CO₃)₄(OH)₂·4H₂O) and at least a water soluble or water dispersible source of alkali ions wherein the water soluble or water dispersible source of alkali ions is selected from alkali carbonate and/or alkali bicarbonate.

In case the storage stabilization agent that is used for stabilizing an aqueous home care formulation upon storage comprises or consists of three different water soluble or water dispersible ion sources, the storage stabilization agent might comprise, or consist of, water soluble or water dispersible source of bismuth ions and water soluble or water dispersible source of lithium ions and water dispersible source of magnesium ions wherein the water dispersible source of magnesium ions is selected from magnesium carbonate or magnesite (MgCO₃) and/or hydromagnesite (Mg₅(CO₃)₄(OH)₂·4H₂O), or water soluble or water dispersible source of bismuth ions and water soluble or water dispersible source of lithium ions and water soluble or water dispersible source of lithium ions and at least a water soluble or water dispersible source of alkali ions wherein the water soluble or water dispersible source of alkali ions is selected from alkali carbonate and/or alkali bicarbonate, or water soluble or water dispersible source of bismuth ions and water dispersible source of magnesium ions wherein the water dispersible source of magnesium ions is selected from magnesium carbonate or magnesite (MgCO₃) and/or hydromagnesite (Mg₅(CO₃)₄(OH)₂·4H₂O) and water soluble or water dispersible source of alkali ions wherein the water soluble or water dispersible source of alkali ions is selected from alkali carbonate and/or alkali bicarbonate, or water soluble or water dispersible source of lithium ions and water dispersible source of magnesium ions wherein the water dispersible source of magnesium ions is selected from magnesium carbonate or magnesite (MgCO₃) and/or hydromagnesite (Mg₅(CO₃)₄(OH)₂·4H₂O) and water soluble or water dispersible source of alkali ions wherein the water soluble or water dispersible source of alkali ions is selected from alkali carbonate and/or alkali bicarbonate.

In case the storage stabilization agent that is used for stabilizing an aqueous home care formulation upon storage comprises or consists of four different water soluble or water dispersible ion sources, the storage stabilization agent might comprise, or consist of, water soluble or water dispersible source of bismuth ions and water soluble or water dispersible source of lithium ions and water dispersible source of magnesium ions wherein the water dispersible source of magnesium ions is selected from magnesium carbonate or magnesite (MgCO₃) and/or hydromagnesite (Mg₅(CO₃)₄(OH)₂·4H₂O) and water soluble or water dispersible source of alkali ions wherein the water soluble or water dispersible source of alkali ions is selected from alkali carbonate and/or alkali bicarbonate.

In an exemplary embodiment the storage stabilization agent that is used for stabilizing an aqueous home care formulation upon storage comprises or consists of two different water soluble or water dispersible ion sources as described above or comprises or consists of three different water soluble or water dispersible ion sources as described above. According to a preferred embodiment the storage stabilization agent that is used for stabilizing an aqueous home care formulation upon storage comprises or consists of two different water soluble or water dispersible ion sources as described above.

According to an exemplary embodiment of the present invention, the storage stabilization agent that is used for stabilizing the aqueous home care formulation upon storage comprises, preferably consists of two different water soluble or water dispersible ion sources as described above, preferably consists of bismuth chloride or bismuth oxide and lithium citrate or lithium carbonate, or bismuth chloride or bismuth oxide and precipitated hydromagnesite, or bismuth chloride or bismuth oxide and sodium carbonate, or lithium citrate or lithium carbonate and precipitated hydromagnesite, or lithium citrate or lithium carbonate and sodium carbonate, or precipitated hydromagnesite and sodium carbonate

According to one embodiment of the present invention, the storage stabilization agent that is used for stabilizing an aqueous home care formulation upon storage is used in solid form, preferably in form of a particulate material. The term “solid” according to the present invention refers to a material that is solid under standard ambient temperature and pressure (SATP) which refers to a temperature of 298.15 K (25° C.) and an absolute pressure of exactly 1 bar. The solid may be in the form of a powder, tablet, granules, flakes etc.

According to another embodiment of the present invention, the storage stabilization agent that is used for stabilizing an aqueous home care formulation upon storage is used in a liquid medium. Accordingly, the term “liquid medium” refers to a material that is liquid under standard ambient temperature and pressure (SATP) which refers to a temperature of 298.15 K (25° C.) and an absolute pressure of exactly 1 bar. According to a preferred embodiment of the present invention, the storage stabilization agent comprises water and forms a solution or a dispersion or slurry.

The term “solution” in the meaning of the present invention refers to a storage stabilization agent dissolved in water in which no discrete solid particles are observed in the solvent, i.e. a solution with water is formed, wherein the water soluble or water dispersible source of bismuth ions and/or the water soluble or water dispersible source of lithium ions and/or the water soluble or water dispersible source of alkali ions are dissolved in the water.

The term “dispersion” or “suspension” in the meaning of the present invention refers to a storage stabilization agent dissolved in water, wherein at least a part of the water soluble or water dispersible source of bismuth ions and/or the water soluble or water dispersible source of lithium ions and/or the water soluble or water dispersible source of alkali ions are dissolved in the water and/or water dispersible source of magnesium ions are present as insoluble solids in the water.

In addition to the water further solvents may be present in the liquid phase. The solvents are water-miscible organic solvent, preferably selected from the group comprising methanol, ethanol, acetone, acetonitrile, tetrahydrofuran and mixtures thereof.

For example, the liquid phase comprises water and at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase. According to a preferred embodiment of the present invention the storage stabilization agent that is used for stabilizing the aqueous home care formulation upon storage only consists of water as liquid phase and no further solvents.

In view of this, the storage stabilization agent that is used for stabilizing an aqueous home care formulation upon storage can be used in an undiluted, i.e. concentrated form. In another embodiment of the present invention, the storage stabilization agent that is used for stabilizing an aqueous home care formulation upon storage can be used diluted to a suitable concentration. In the diluted form, the storage stabilization agent is preferably dissolved in water, wherein the corresponding diluted composition comprises preferably 0.001 to 20.0 wt.-% of the storage stabilization agent and most preferably 0.01 to 15 wt.-% of the storage stabilization agent, based on the total weight of the composition.

It is preferred that the storage stabilization agent that is used for stabilizing an aqueous home care formulation upon storage is evenly distributed in the water and the optional organic solvent. However, in order to avoid an excessive dilution of the storage stabilization agent and the home care formulation, it is preferred to keep the water content in the storage stabilization agent as low as possible or as low as necessary.

When the storage stabilization agent is used for stabilizing an aqueous home care formulation, it is appreciated that each of the water soluble or water dispersible ion sources present in the home care formulation selected from the group consisting of water soluble or water dispersible source of bismuth ions, water soluble or water dispersible source of lithium ions, water dispersible source of magnesium ions and at least a water soluble or water dispersible source of alkali ions are each present in the composition in an amount of at least 1000 ppm to 50000 ppm, based on the total weight of the aqueous home care formulation.

According to one embodiment of the present invention, when the storage stabilization agent is used for stabilizing an aqueous home care formulation each of the water soluble or water dispersible ion sources present in the home care formulation selected from the group consisting of water soluble or water dispersible source of bismuth ions, water soluble or water dispersible source of lithium ions, water dispersible source of magnesium ions and at least a water soluble or water dispersible source of alkali ions are each present in the composition in an amount of 2500 ppm to 20000 ppm, based on the total weight of the home care formulation, even more preferably in an amount from 3000 to 10000 ppm, ad most preferably from 2500 to 5000 ppm, based on the total weight of the aqueous home care formulation.

That is to say, the storage stabilization agent is used for stabilizing an aqueous home care formulation upon storage, wherein
a) the water soluble or water dispersible source of bismuth ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation and/or
b) the water soluble or water dispersible source of lithium ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation and/or
c) the water dispersible source of magnesium ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation and/or
d) the water soluble or water dispersible source of alkali ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation,
   with the provision that at least two different water soluble or water dispersible ion sources are present.

For example, the storage stabilization agent is used for stabilizing an aqueous home care formulation upon storage, wherein
a) the water soluble or water dispersible source of bismuth ions is present in an amount from 1000 to 50000 ppm, preferably in an amount from 1000 to 20000 ppm, even more preferably in an amount from 1000 to 10000 ppm, even more preferably in an amount from 1000 to 5000 ppm, and most preferably in an amount from 1000 to 2500 ppm based on the total weight of the home care formulation and/or
b) the water soluble or water dispersible source of lithium ions is present in an amount from 250 to 50000 ppm, preferably in an amount from 250 to 20000 ppm, even more preferably in an amount from 250 to 10000 ppm, even more preferably in an amount from 250 to 5000 ppm and most preferably in an amount from 250 to 2500 ppm, based on the total weight of the home care formulation and/or
c) the water dispersible source of magnesium ions is present in an amount from 1000 to 50000 ppm, preferably in an amount from 1000 to 20000 ppm, even more preferably in an amount from 1000 to 10000 ppm, even more preferably in an amount from 1000 to 5000 ppm, and most preferably in an amount from 1000 to 2500 ppm, based on the total weight of the home care formulation and/or
d) the water soluble or water dispersible source of alkali ions is present in an amount from 1000 to 50000 ppm, preferably in an amount from 1000 to 20000 ppm, even more preferably in an amount from 1000 to 10000 ppm, even more preferably in an amount from 1000 to 5000 ppm, and most preferably in an amount from 1000 to 2500 ppm based on the total weight of the home care formulation,
with the provision that at least two different water soluble or water dispersible ion sources are present.

According to a preferred embodiment, the storage stabilization agent is used for stabilizing an aqueous home care formulation upon storage, wherein
a) the water soluble or water dispersible source of bismuth ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation and/or
b) the water soluble or water dispersible source of lithium ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation and/or
c) the water dispersible source of magnesium ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation, wherein the water dispersible source of magnesium ions is hydromagnesite and/or
d) the water soluble or water dispersible source of alkali ions is present in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation,
   with the provisio that at least two different water soluble or water dispersible ion sources are present.

According to another embodiment of the present invention the storage stabilization agent that is used for stabilizing an aqueous home care formulation upon storage comprises water and preferably has a pH value in the range from 7 to 14, preferably from 7.5 to 11.5, even more preferably from 8 to 11.

The pH value is measured at 25° C. using a Mettler Toledo Seven Easy pH meter and a Mettler Toledo InLab Expert Pro pH electrode. A three point calibration (according to the segment method) of the instrument is first made using commercially available buffer solutions having pH values of 4, 7 and 10 at 25° C. (from Aldrich). The reported pH values are the endpoint values detected by the instrument (signal differs by less than 0.1 mV from the average over the last 6 seconds).

According to another preferred embodiment of the present invention, the weight ratio of the at least two different water soluble or water dispersible ion sources present in the storage stabilization agent is from 100:1 to 1:100, preferably from 10:1 to 1:10 and most preferably from 5:1 to 1:5.

In case the storage stabilization agent comprises or consist of three or four different water soluble or water dispersible ion sources, the weight ration of each of the water soluble or water dispersible sources to one another is from 100:1 to 1:100, preferably from 10:1 to 1:10 and most preferably from 5:1 to 1:5.

According to another embodiment of the present invention, the storage stabilization agent that is used in the present invention comprises further additives selected from the group consisting of dispersing agents, viscosity agents, thickeners, rheological additives and defoaming agents. Such further additives are known to the skilled person and are commercially available.

The storage stabilization agent is used for stabilizing an aqueous home care formulation upon storage. By “stabilizing upon storage” it is meant that an aqueous composition is stabilized for a defined amount of time against microorganisms and optionally against pH change. More precisely, by stabilizing upon storage it is meant that an aqueous composition, stored motionless at 25° C., does prevent or reduce the growth and/or reproduction of microorganisms for at least 15 days and optionally does not exhibit a change in the pH value of more than +/−1 for at least 15 days.

It is preferred that the microorganisms are selected from the group comprising at least one strain of bacteria, at least one strain of fungi, such as mold or yeast, algae and mixtures thereof.

In one embodiment of the present invention, the at least one strain of bacteria is selected from the group consisting of gram-negative bacteria, gram-positive bacteria and mixtures thereof.

It is appreciated that gram-positive and gram-negative bacteria are well known in the art and are e.g. described in Biology of Microorganisms, “Brock”, Madigan MT, Martinko JM, Parker J, 1997, 8^{th} Edition. In particular, such bacteria represent evolutionary very distantly related classes of bacteria each comprising of many bacterial families. Gram negative bacteria are characterized by two membranes (outer and inner membrane) while gram positive bacteria contain only one membrane. Usually, the former contains a high amount of lipopolysaccharide and a thin single-layer of peptidoglycan, while the latter has virtually no lipopolysaccharide, a multi-layered thick peptidoglycan and the coat contains teichoic acids. For these differences, the Gram positive and Gram negative bacteria react differently on environmental influences. Methods for discriminating gram-positive and gram-negative bacteria include species identification by DNA sequencing techniques or biochemical characterisations. Alternatively, the number of membranes can be determined directly by thin section transmission electron microscopy.

The term “at least one strain of bacteria” in the meaning of the present invention means that the strain of bacteria comprises, preferably consists of, one or more strains of bacteria.

In one embodiment of the present invention, the at least one strain of bacteria comprises, preferably consists of, one strain of bacteria. Alternatively, the at least one strain of bacteria comprises, preferably consists of, two or more strains of bacteria. For example, the at least one strains of bacteria comprises, preferably consists of, two or three strains of bacteria. Preferably, the at least one strain of bacteria comprises, preferably consists of, two or more strains of bacteria.

In one embodiment, the storage stabilization agent is used for stabilizing an aqueous home care formulation against at least one strain of bacteria which is selected from the group consisting of Pseudomonas sp., such as Pseudomonas aeruginosa, Pseudomonas pseudoalcaligenes, Pseudomonas putida, Pseudomonas stutzeri, Pseudomonas mendocina, Pseudomonas oleovorans subsp. Oleovorans, and mixtures thereof, Burkholderia sp., such as Burkholderia cepacia; Escherichia spp. such as Escherichia coli; Alcaligenes sp. such as Alcaligenes faecalis; Staphylococcus sp. such as Staphylococcus aureus; Enterococcus sp. such as Enterococcus faecalis; Bacillus sp. such as Bacillus halodurans; Salmonella sp.; Legionella, Comomonas aquatica, Brevundimonas intermedia, Rhizobium radiobacter, Spingobium yanoikuyae, Caldimonas sp., Hydrogenophaga sp., Alishewanella agri, Arthrobacter sp., Chryseomicrobium amylolyticum, Microbacterium sp., Exiguobacterium aurantiacum, and mixtures thereof.

For example, the storage stabilization agent is used for stabilizing an aqueous home care formulation against at least one strain of bacteria which is selected from the group comprising Pseudomonas sp., such as Pseudomonas aeruginosa, Pseudomonas pseudoalcaligenes, Pseudomonas putida, and mixtures thereof, Burkholderia sp., such as Burkholderia cepacia; Escherichia spp. such as Escherichia coli; Alcaligenes sp. such as Alcaligenes faecalis; Staphylococcus sp. such as Staphylococcus aureus; Enterococcus sp. such as Enterococcus faecalis; Bacillus sp.; Salmonella sp.; Legionella, and mixtures thereof.

Additionally or alternatively, the storage stabilization agent is used for stabilizing an aqueous home care formulation against at least one strain of fungi which is selected from the group comprising Saccharomyces cerevisiae, Pichia membranifaciens, Rhodotorula mucilaginosa Fusarium sp., Aspergillus sp. such as Aspergillus niger, Aspergillus brasiliensis, and mixtures thereof, Penicillium sp. such as Penicillium pinophilum, Penicillium funiculosum, and mixtures thereof, Aureobasidium pullulans, Geotrichum sp., Acremonium sp., Alternaria sp., Cladosporium sp., Mucor sp., Rhizopus sp., Stachybotrys sp., Trichoderma sp., Dematiaceae sp., Phoma sp., Eurotium sp., Scopulariopsis sp., Aureobasidium sp., Monilia sp., Botrytis sp., Stemphylium sp., Chaetomium sp., Mycelia sp., Neurospora sp., Ulocladium sp., Paecilomyces sp., Wallemia sp., Curvularia sp., and mixtures thereof.

For example, the storage stabilization agent is used for stabilizing an aqueous home care formulation against at least one strain of fungi which is selected from the group comprising Saccharomyces cerevisiae, Pichia membranifaciens, Rhodotorula mucilaginosa Fusarium sp., Aspergillus sp., and mixtures thereof.

It is appreciated that moulds and yeasts are subclasses of fungis. Accordingly, the at least one strain of fungi can be at least one strain of mould or at least one strain of yeast.

Thus, the storage stabilization agent can be used for stabilizing an aqueous home care formulation against at least one strain of mould which is selected from the group comprising Acremonium sp., Alternaria sp., Aspergillus sp., Cladosporium sp., Fusarium sp., Mucor sp., Penicillium sp., Rhizopus sp., Stachybotrys sp., Trichoderma sp., Dematiaceae sp., Phoma sp., Eurotium sp., Scopulariopsis sp., Aureobasidium sp., Monilia sp., Botrytis sp., Stemphylium sp., Chaetomium sp., Mycelia sp., Neurospora sp., Ulocladium sp., Paecilomyces sp., Wallemia sp., Curvularia sp., and mixtures thereof.

The term “at least one strain of mould” in the meaning of the present invention means that the strain of mould comprises, preferably consists of, one or more strains of mould.

In one embodiment of the present invention, the at least one strain of mould comprises, preferably consists of, one strain of mould. Alternatively, the at least one strain of mould comprises, preferably consists of, two or more strains of mould. For example, the at least one strain of mould comprises, preferably consists of, two or three strains of mould. Preferably, the at least one strain of mould comprises, preferably consists of, two or more strains of mould.

Additionally or alternatively, the storage stabilization agent can be used for stabilizing an aqueous home care formulation against at least one strain of yeast which is selected from the group comprising Saccharomyces cerevisiae, Pichia membranifaciens, Rhodotorula mucilaginosa, and mixtures thereof.

The term “at least one strain of yeast” in the meaning of the present invention means that the strain of yeast comprises, preferably consists of, one or more strains of yeast.

In one embodiment of the present invention, the at least one strain of yeast comprises, preferably consists of, one strain of yeast. Alternatively, the at least one strain of yeast comprises, preferably consists of, two or more strains of yeast. For example, the at least one strain of yeast comprises, preferably consists of, two or three strains of yeast. Preferably, the at least one strain of yeast comprises, preferably consists of, two or more strains of yeast.

Additionally or alternatively, the storage stabilization agent can be used for stabilizing an aqueous home care formulation against at least one strain of algae which is selected from the group comprising Chlorella vulgaris, Chlorella emersonii, Stichococcus bacillaris, Pleurococcus sp., Anacystis montana, and mixtures thereof.

The term “at least one strain of algae” in the meaning of the present invention means that the strain of algae comprises, preferably consists of, one or more strains of algae.

In one embodiment of the present invention, the at least one strain of algae comprises, preferably consists of, one strain of algae. Alternatively, the at least one strain of algae comprises, preferably consists of, two or more strains of algae. For example, the at least one strain of algae comprises, preferably consists of, two or three strains of algae. Preferably, the at least one strain of algae comprises, preferably consists of, two or more strains of algae.

The storage stabilization agent is used for stabilizing an aqueous home care formulation upon storage. More precisely, the storage stabilization agent is used for stabilizing an aqueous home care formulation upon storage for a defined amount of time against microorganisms and optionally against pH change. More precisely, the storage stabilization agent is used for stabilizing an aqueous home care formulation upon storage, when stored motionless at 25° C., and does prevent or reduce the growth and/or reproduction of microorganisms and optionally does not exhibit a change in the pH value of more than +/−1, for at least 15 days, preferably for at least 20 days more preferably for at least 30 days, even more preferably at least 60 days and most preferably at least 90 days without the use of conventional antimicrobials which might be toxic and/or harmful to humans, animals and/or the environment.

Thus, the storage stabilization agent that is used for stabilizing an aqueous home care formulation upon storage and the aqueous home care formulation are preferably free of an antimicrobial selected from the group comprising phenols, halogenated phenols, halogen-containing compounds, halogen-releasing compounds, isothiazolinones, aldehyde-containing compounds, aldehyde-releasing compounds, guanidines, sulfones, thiocyanates, pyrithiones, antibiotics such as β-lactam antibiotics, quaternary ammonium salts, peroxides, perchlorates, amides, amines, heavy metals, biocidal enzymes, biocidal polypeptides, azoles, carbamates, glyphosates, sulphonamides and mixtures thereof. Such antimicrobials are well known to the skilled person.

However, it is to be noted that it is not excluded that the storage stabilization agent that is used for stabilizing an aqueous home care formulation upon storage further comprises minor amounts of an antimicrobial in order to increase the antimicrobial efficiency of the storage stabilization agent against microorganisms.

The storage stabilization agent is used for stabilizing an aqueous home care formulation upon storage. Aqueous home care formulations are known to the skilled person. For example, the aqueous home care formulation is a washing formulation, preferably for cleaning of laundry, fabrics, dishes and hard surfaces; a pre-washing formulation; a rinsing formulation; a bleaching formulation; a laundry fabric-softener formulation; a cleaning formulation; and mixtures thereof.

According to an exemplified use of the present invention, the storage stabilization agent that is used for stabilizing an aqueous home care formulation upon storage comprises, preferably consist of two different water soluble or water dispersible ion sources as described above, preferably consists of bismuth chloride or bismuth oxide and lithium citrate or lithium carbonate, or bismuth chloride or bismuth oxide and precipitated hydromagnesite, or bismuth chloride or bismuth oxide and sodium carbonate, or lithium citrate or lithium carbonate and precipitated hydromagnesite, or lithium citrate or lithium carbonate and sodium carbonate, or precipitated hydromagnesite and sodium carbonate, wherein
a) the bismuth chloride or bismuth oxide is present in an amount from 1000 to 2500 ppm based on the total weight of the home care formulation and/or
b) the lithium citrate or lithium carbonate is present in an amount from 250 to 2500 ppm, based on the total weight of the home care formulation and/or
c) the precipitated hydromagnesite is present in an amount from 1000 to 2500 ppm, based on the total weight of the home care formulation and/or
d) the sodium carbonate is present in an amount from 1000 2500 ppm based on the total weight of the home care formulation.

According to a preferred embodiment of the present invention, the storage stabilization agent is used for stabilizing an aqueous home care formulation, wherein the storage stabilization agent comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions,
wherein the water soluble or water dispersible source of alkali ions is selected from alkali carbonate and/or alkali bicarbonate and
wherein the water dispersible source of magnesium ions is hydromagnesite (Mg₅(CO₃)₄(OH)₂·4H₂O) and
does not comprise a water soluble or water dispersible source of zinc ions.

In addition to that in a preferred embodiment no further antimicrobials and/or biocides are necessary to prevent or reduce microbial growth and, therefore, no further antimicrobials and/or biocides are used for stabilizing an aqueous home care formulation.

The inventors surprisingly found that the inventive storage stabilization agent can be used to stabilize an aqueous home care formulation upon storage. More precisely, the storage stabilization agent stabilizes the aqueous home care formulation for a defined amount of against microorganisms. Furthermore, in addition to the storage stabilization agent no further antimicrobials and/or biocides are necessary to prevent or reduce microbial growth. Furthermore, the inventive storage stabilization agent is easy to handle and transport, cheap, and is not toxic to humans, animals and/or the environment.

### The Storage Stabilization Agent

According to another embodiment of the present invention, the present invention refers to a storage stabilization agent for stabilizing an aqueous home care formulation upon storage, comprising at least two different water soluble or water dispersible ion sources selected from the group consisting of water soluble or water dispersible source of bismuth ions, water soluble or water dispersible source of lithium ions, water dispersible source of magnesium ions and at least on water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

With regard to the definition of the storage stabilization agent, the microorganisms and preferred embodiments thereof, reference is made to the statements provided above when discussing the technical details of the use of the storage stabilizing agent for stabilizing an aqueous home care formulation upon storage.

According to a preferred embodiment of the present invention, the storage stabilization agent for stabilizing an aqueous home care formulation upon storage, comprises at least two different water soluble or water dispersible ion sources selected from the group consisting of water soluble or water dispersible source of bismuth ions, water soluble or water dispersible source of lithium ions, water dispersible source of magnesium ions and at least on water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O) with the proviso that if one of the water soluble or water dispersible ion sources is a water dispersible source of magnesium ions, the second water soluble or water dispersible ion source is not at least on water soluble or water dispersible source of alkali ions. More precisely, if one of the water soluble or water dispersible ion sources is a water dispersible source of magnesium ions, wherein the water dispersible source of magnesium ions is selected from magnesium carbonate or magnesite (MgCO₃) and/or hydromagnesite (Mg₅(CO₃)₄(OH)₂·4H₂O), then the second water soluble or water dispersible ion source is selected from the group consisting of water soluble or water dispersible source of bismuth ions and water soluble or water dispersible source of lithium ions.

According to a preferred embodiment of the present invention, the storage stabilization agent for stabilizing an aqueous home care formulation upon storage, comprises at least two different water soluble or water dispersible ion sources selected from the group consisting of water soluble or water dispersible source of bismuth ions, water soluble or water dispersible source of lithium ions, water dispersible source of magnesium ions and at least on water soluble or water dispersible source of alkali ions, wherein the water soluble or water dispersible source of alkali ions is selected from alkali carbonate and/or alkali bicarbonate and wherein the water dispersible source of magnesium ions is hydromagnesite (Mg₅(CO₃)₄(OH)₂·4H₂O) with the proviso that if one of the water soluble or water dispersible ion sources is a water dispersible source of magnesium ions, the second water soluble or water dispersible ion source is not at least on water soluble or water dispersible source of alkali ions. More precisely, if one of the water soluble or water dispersible ion sources is a water dispersible source of magnesium ions, wherein the water dispersible source of magnesium ions is hydromagnesite (Mg₅(CO₃)₄(OH)₂·4H₂O), then the second water soluble or water dispersible ion source is selected from the group consisting of water soluble or water dispersible source of bismuth ions and water soluble or water dispersible source of lithium ions.

According to a preferred embodiment of the present invention, the storage stabilization agent for stabilizing an aqueous home care formulation upon storage, comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions, wherein the water soluble or water dispersible source of alkali ions is selected from alkali carbonate and/or alkali bicarbonate and is not a sodium ion and wherein the water dispersible source of magnesium ions is selected from magnesium carbonate or magnesite (MgCO₃) and/or hydromagnesite (Mg₅(CO₃)₄(OH)₂·4H₂O), and does not comprise a water soluble or water dispersible source of zinc ions. Furthermore, if the first compound is a water soluble or water dispersible source of bismuth ions than the second compound is not a water dispersible source of magnesium ions.

According to another preferred embodiment of the present invention, the storage stabilization agent for stabilizing an aqueous home care formulation upon storage, comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions, wherein the water soluble or water dispersible source of alkali ions is selected from alkali carbonate and/or alkali bicarbonate and is not a sodium ion and wherein the water dispersible source of magnesium ions is hydromagnesite (Mg₅(CO₃)₄(OH)₂·4H₂O), and does not comprise a water soluble or water dispersible source of zinc ions. Furthermore, if the first compound is a water soluble or water dispersible source of bismuth ions than the second compound is not a water dispersible source of magnesium ions.

### The Aqueous Home Care Formulation

According to the present invention the storage stabilization agent is used to stabilize an aqueous home care formulation upon storage. More precisely, the aqueous home care formulation comprises the storage stabilization agent.

With regard to the definition of the storage stabilization agent and preferred embodiments thereof, and its use reference is made to the statements provided above when discussing the technical details of the storage stabilization agent of the present invention and its use.

The aqueous home care formulation is preferably a washing formulation, preferably for cleaning of laundry, fabrics, dishes and hard surfaces; a pre-washing formulation; a rinsing formulation; a bleaching formulation; a laundry fabric-softener formulation; a cleaning formulation; and mixtures thereof.

The term “aqueous” home care formulation refers to a system, wherein the liquid phase of the home care formulation or composition comprises, preferably consists of, water. However, said term does not exclude that the aqueous home care formulation or composition comprises an organic solvent preferably selected from the group comprising methanol, ethanol, acetone, acetonitrile, tetrahydrofuran and mixtures thereof. If the aqueous home care formulation or composition comprises an organic solvent, the aqueous home care formulation or composition comprises the organic solvent in an amount up to 40.0 wt.-% preferably from 0.1 to 30.0 wt.-% and most preferably from 0.1 to 20.0 wt.-%, and preferably 0.1 to 10 wt.-% based on the total weight of the liquid phase of the aqueous home care formulation or composition.

According to a preferred embodiment, the liquid phase of the aqueous home care formulation or composition consists of water. If the liquid phase of the aqueous home care formulation or composition consists of water, the water to be used can be any water available such as tap water and/or deionised water.

According to one embodiment of the present invention, the inventive storage stabilization agent is present in an amount such that the aqueous home care formulation is preserved against microorganisms for at least 15 days, preferably for at least 20 days more preferably for at least 30 days, even more preferably at least 60 days and most preferably at least 90 days. Optionally, also the pH value of the aqueous home care formulation is stabilized.

More precisely, when stored motionless at 25° C., the aqueous home care formulation comprising the storage stabilization agent does prevent or reduce the growth and/or reproduction of microorganisms for at least 15 days, preferably for at least 20 days more preferably for at least 30 days, even more preferably at least 60 days and most preferably at least 90 days and optionally does not exhibit a change in the pH value of more than +/−1 within the same time limit.

According to the present invention, the wording “prevents microbial growth” means that no significant growth of microorganisms such as at least one strain of bacteria, at least one strain of fungi, such as mold or yeast, algae and mixtures thereof is observed in the aqueous home care formulation when the storage stabilization agent is present. This preferably does not lead to an increase of the cfu value in the treated aqueous home care formulation compared to the preparation immediately before treatment, more preferably to a decrease of the value to less than 100 cfu/1 ml or 1 g of the aqueous home care formulation, using the bacterial count method described in the example section herein. It is appreciated that the final aqueous preparation, i.e. comprising the storage stabilization agent, is diluted by a factor of 10 and 100 μl of the diluted composition is then plated out in order to evaluate the microbial growth.

According to the present invention, the wording “reduce microbial growth” means that growth of microorganisms such as at least one strain of bacteria, at least one strain of fungi, such as mold or yeast, algae and mixtures thereof is slower in the aqueous home care formulation when the storage stabilization agent is present. This preferably leads to a lower cfu value in the treated aqueous home care formulation compared to the home care formulation without the storage stabilization agent before treatment, more preferably to a value of less than 100 cfu/1 ml or 1 g of the aqueous home care formulation, using the bacterial count method described in the example section herein. It is appreciated that the final aqueous home care formulation, i.e. comprising the storage stabilization agent, is diluted by a factor of 10 and 100 μl of the diluted composition is then plated out in order to evaluate the microbial growth.

The pH value is measured at 25° C. using a Mettler Toledo Seven Easy pH meter and a Mettler Toledo InLab Expert Pro pH electrode. A three point calibration (according to the segment method) of the instrument is first made using commercially available buffer solutions having pH values of 4, 7 and 10 at 25° C. (from Aldrich). The reported pH values are the endpoint values detected by the instrument (signal differs by less than 0.1 mV from the average over the last 6 seconds).

According to another embodiment of the present invention, the aqueous home care formulation can comprise at least one inorganic particulate material. The presence of the at least one inorganic particulate material depends on the consistency and the use of the aqueous home care formulation.

The term “at least one” inorganic particulate material in the meaning of the present invention means that the inorganic particulate material comprises, preferably consists of, one or more inorganic particulate materials.

In one embodiment of the present invention, the at least one inorganic particulate material comprises, preferably consists of, one inorganic particulate material. Alternatively, the at least one inorganic particulate material comprises, preferably consists of, two or more inorganic particulate materials. For example, the at least one inorganic particulate material comprises, preferably consists of, two or three inorganic particulate material. Preferably, the at least one inorganic particulate material comprises, preferably consists of, one inorganic particulate material.

For example, the at least one inorganic particulate material is selected from the group comprising natural ground calcium carbonate, natural and/or synthetic precipitated calcium carbonate, surface-modified calcium carbonate, dolomite, kaolin, clay, barite, talcum, aluminium hydroxide, aluminium silicate, titanium dioxide, perlite, sepiolite, brucite and mixtures thereof.

In one embodiment of the present invention, the at least one inorganic particulate material comprises natural ground calcium carbonate and/or synthetic precipitated calcium carbonate and/or surface-modified calcium carbonate. Preferably, the at least one inorganic particulate material comprises natural ground calcium carbonate and/or synthetic precipitated calcium carbonate and most preferably comprises natural ground calcium carbonate. Such an inorganic particulate material is especially preferred in case the aqueous home care formulation should have abrasive features. In that case it is preferred that the aqueous home care formulation has a creamy or milky consistency with a high Brookfield viscosity in order to avoid a settlement of the inorganic particulate material in the aqueous home care formulation.

“Ground calcium carbonate” (GCC) in the meaning of the present invention is a calcium carbonate obtained from natural sources, such as limestone, marble or chalk, and processed through a treatment such as grinding, screening and/or fractionizing by wet and/or dry, for example by a cyclone or classifier.

“Precipitated calcium carbonate” (PCC) in the meaning of the present invention is a synthesized material, generally obtained by precipitation following reaction of carbon dioxide and lime in an aqueous environment or by precipitation of a calcium and carbonate ion source in water.

A “surface-modified calcium carbonate” may feature surface-reacted GCC or PCC. A surface-reacted calcium carbonate may be prepared by providing a GCC or PCC in form of an aqueous suspension, and adding an acid to said suspension. Suitable acids are, for example, sulphuric acid, hydrochloric acid, phosphoric acid, citric acid, oxalic acid, or a mixture thereof. In a next step, the calcium carbonate is treated with gaseous carbon dioxide. If a strong acid such as sulphuric acid or hydrochloric acid is used for the acid treatment step, the carbon dioxide will form automatically in situ. Alternatively or additionally, the carbon dioxide can be supplied from an external source. Surface-reacted calcium carbonates are described, for example, in US20120031576 A1, WO2009074492 A1, EP2264109 A1, EP2070991 A1, EP2264108 A1, WO0039222 A1, WO2004083316 A1 or WO2005121257 A2.

The natural ground calcium carbonate and/or synthetic precipitated calcium carbonate and/or surface-modified calcium carbonate may additionally be surface treated or may comprise a dispersing agent well known to the skilled person. For example, the dispersing agent may be an acrylate-based dispersing agent.

If the aqueous home care formulation comprises at least one inorganic particulate material, the at least one inorganic particulate material may have a particle size distribution as conventionally employed for the material(s) involved in the type of product to be produced. In general, 90% of the particles will have an esd (equivalent spherical diameter as measured by the well-known technique of sedimentation using Sedigraph 5120 series, Micromeritics) of less than 5 μm. Coarse inorganic particulate materials may have a particle esd generally (i.e., at least 90 wt.-%) in the range of 1 to 5 μm. Fine inorganic particulate materials may have a particle esd generally less than 2 μm, e.g. 50.0 to 99.0 wt.-% less than 2 μm and preferably 60.0 to 90.0 wt.-% less than 2 μm. It is preferred that the at least one inorganic particulate material in the aqueous preparation has a weight median particle size d₅₀ value of from 0.1 to 5 μm, preferably from 0.2 to 2 μm and most preferably from 0.35 to 1 μm, for example 0.7 μm as measured using a Sedigraph™ 5120 of Micromeritics Instrument Corporation.

The “particle size” of inorganic particulate materials as described above that might be present in the home care formulation is described by its distribution of particle sizes dₓ(wt). Therein, the value dₓ(wt) represents the diameter relative to which x % by weight of the particles have diameters less than dₓ(wt). This means that, for example, the d₂₀(wt) value is the particle size at which 20 wt. % of all particles are smaller than that particle size. The d₅₀(wt) value is thus the weight median particle size, i.e. 50 wt. % of all particles are smaller than that particle size and the d₉₈(wt) value, referred to as weight-based top cut, is the particle size at which 98 wt. % of all particles are smaller than that particle size. The weight-based median particle size d₅₀(wt) and top cut d₉₈(wt) are measured by the sedimentation method, which is an analysis of sedimentation behaviour in a gravimetric field. The measurement is made with a Sedigraph™ 5120 of Micromeritics Instrument Corporation, USA. The method and the instrument are known to the skilled person and are commonly used to determine particle size distributions. The measurement is carried out in an aqueous solution of 0.1 wt. % Na₄P₂O₇. The samples are dispersed using a high speed stirrer and sonication.

For keeping such inorganic particulate materials dispersed in an aqueous home care formulation and thus ensuring that the viscosity of the preparation remains substantially the same over time, additives such as dispersing agents can be used. A suitable dispersing agent according to the present invention is preferably a homo or copolymer made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, styrene, the esters of acrylic and methacrylic acids and mixtures thereof, wherein salts of poly(acrylic acid) and/or poly (methacrylic acid) are preferred as dispersing agent.

Additionally or alternatively, the aqueous home care formulation comprises at least one organic particulate material. For example, the at least one organic material is selected from the group comprising carbohydrates such as CMC or starch, sugar, cellulose, modified cellulose and cellulose based pulp, glycerol, hydrocarbons and mixtures thereof.

In one embodiment of the present invention, the aqueous home care formulation comprises at least one inorganic particulate material, preferably being selected from the group comprising natural ground calcium carbonate, natural and/or synthetic precipitated calcium carbonate, surface-modified calcium carbonate, dolomite, kaolin, clay, barrite, talcum, aluminium hydroxide, aluminium silicate, titanium dioxide, perlite, sepiolite, brucite and mixtures thereof, and most preferably the at least one inorganic particulate material comprises natural ground calcium carbonate and/or synthetic precipitated calcium carbonate.

Thus, the aqueous home care formulation is preferably an aqueous suspension or slurry.

It is appreciated that the solids content of the aqueous home care formulation can be up to 85.0 wt.-%. For example, the solids content of the aqueous home care formulation is from 10.0 to 82.0 wt.-%, and more preferably from 20.0 to 80.0 wt.-%, based on the total weight of the aqueous home care formulation.

The total solids content in the meaning of the present application corresponds to the residual weight of the aqueous home care formulation after drying for 3 h at 105° C. as measured in a sample of at least 3 to 5 g.

The pH of the aqueous home care formulation can vary in a broad range and is preferably in a pH range typically observed for such aqueous home care formulation. It is thus appreciated that the aqueous home care formulation preferably has a pH value of from 7 to 14, preferably from 7.5 to 11.5 and more preferably from 8 to 11.

Typically, the aqueous home care formulation has a viscosity being preferably in the range from 50 to 2000 mPa·s and preferably from 80 to 800 mPa·s. The Brookfield viscosity is for this purpose measured by a Brookfield DV-II+ Pro viscometer at 25° C.±1° C. at 100 rpm using an appropriate spindle of the Brookfield RV-spindle set and is specified in mPa·s.

The aqueous home care formulation according to the invention can be produced by methods known in the art, by for example, dispersing, suspending or slurring water-insoluble solids, preferably inorganic particulate materials with, if appropriate, addition of a dispersing agent and, if appropriate, further additives in water.

### Process for Stabilizing the Aqueous Home Care Formulation Upon Storage

The present invention also refers to a process for stabilizing the aqueous home care formulation upon storage, said process comprises the steps of
a) providing an aqueous home care formulation, preferably a washing formulation, preferably for cleaning of laundry, fabrics, dishes and hard surfaces; a pre-washing formulation; a rinsing formulation; a bleaching formulation; a laundry fabric-softener formulation; a cleaning formulation; and mixtures thereof,
b) providing a storage stabilization agent as defined herein, and
c) contacting and mixing the aqueous home care formulation of step a) with the storage stabilization agent of step b) in any order for obtaining the stabilized aqueous home care formulation.

With regard to the definition of the aqueous home care formulation, the storage stabilization agent, the microorganisms and preferred embodiments thereof, reference is made to the statements provided above when discussing the technical details of the aqueous home care formulation and the storage stabilization agent of the present invention and its use.

According to step c) of the process of the present invention, the aqueous home care formulation of step a) is contacted and mixed with the storage stabilization agent of step b).

In general, the aqueous home care formulation of step a) and the at least one storage stabilization agent of step b) can be brought into contact by any conventional means known to the skilled person.

It is appreciated that step c) is preferably carried out by adding the storage stabilization agent of step b) to the aqueous home care formulation of step a).

Preferably, the step c) is carried out in that the storage stabilization agent is added to the aqueous home care formulation under mixing. A sufficient mixing may be achieved by shaking the aqueous home care formulation or by agitation, which may provide a more thorough mixing. In one embodiment of the present invention, step c) is carried out under agitation to ensure a thorough mixing of the aqueous home care formulation and the storage stabilization agent. Such agitation can be carried out continuously or discontinuously.

In one embodiment, step c) is carried out in that the storage stabilization agent is added to the aqueous home care formulation in an amount such that the amount of each of the at least one water soluble or water dispersible sources of ions that are present in the storage stabilization are present in the aqueous home care formulation in an amount from 1000 to 50000 ppm, preferably in an amount from 2500 to 20000 ppm, even more preferably in an amount from 3000 to 10000 ppm, and most preferably in an amount from 2500 to 5000 ppm, based on the total weight of the home care formulation.

It is appreciated that the amount of each of the at least one water soluble or water dispersible source of ions that are present in the storage stabilization agent can vary in a great range in the aqueous home care formulation.

It is appreciated that the single components of the storage stabilization agent can be added to the aqueous home care formulation as a pre-mixed composition or in form of the single components.

In one embodiment, the single components of the storage stabilization agent can be added to the aqueous home care formulation in dry form or in form of a solution or slurry or dispersion.

The amount of the water soluble or water dispersible source of bismuth ions, water soluble or water dispersible source of lithium ions, water soluble or water dispersible source of magnesium ions, wherein the water dispersible source of magnesium ions is selected from magnesium carbonate or magnesite (MgCO₃) and/or hydromagnesite (Mg₅(CO₃)₄(OH)₂·4H₂O), and the at least a water soluble or water dispersible source of alkali ions, wherein the water soluble or water dispersible source of alkali ions is selected from alkali carbonate and/or alkali bicarbonate added to the aqueous home care formulation can be individually adjusted depending on the aqueous home care formulation. In particular, the amount of the storage stabilization agent and the single components therein depends on the nature and the occurrence of the at least one water soluble or water dispersible source of bismuth ions, water soluble or water dispersible source of lithium ions, water soluble or water dispersible source of magnesium ions, wherein the water dispersible source of magnesium ions is selected from magnesium carbonate or magnesite (MgCO₃) and/or hydromagnesite (Mg₅(CO₃)₄(OH)₂·4H₂O), and the at least a water soluble or water dispersible source of alkali ions, wherein the water soluble or water dispersible source of alkali ions is selected from alkali carbonate and/or alkali bicarbonate to be used in the aqueous home care formulation. The optimum amount to be employed within the defined ranges can be determined by preliminary tests and test series on a laboratory scale and by supplementary operational tests.

It is appreciated that step c) can be repeated one or more times.

The storage stabilization agent can be added in one or several portions to the aqueous home care formulation. If the storage stabilization agent is added in several portions, the storage stabilization agent can be added in about equal portions or unequal portions to the aqueous preparation.

The stabilized aqueous home care formulation obtained in step c) preferably has a solids content corresponding to the solids content of the aqueous home care formulation provided in step a). It is thus appreciated that the stabilized aqueous home care formulation obtained in step c) preferably has a solids content of up to 85.0 wt.-%, based on the total weight of the stabilized aqueous home care formulation obtained in step c). For example, the solids content of the stabilized aqueous home care formulation obtained in step c) is from 10.0 to 82.0 wt.-%, and more preferably from 20.0 to 80.0 wt.-%, based on the total weight of the stabilized aqueous home care formulation obtained in step c).

Additionally or alternatively, the pH of the stabilized aqueous home care formulation obtained in step c) preferably corresponds to the pH of the aqueous home care formulation provided in step a). Thus, the stabilized aqueous home care formulation obtained in step c) preferably has a pH value of from 7 to 14, preferably from 7.5 to 11.5, and more preferably from 8 to 11.

Typically, the stabilized aqueous home care formulation obtained in step c) has a viscosity being preferably in the range from 50 to 2000 mPa·s and preferably from 80 to 800 mPa·s. The Brookfield viscosity is for this purpose measured by a Brookfield DV-II+ Pro viscometer at 25° C.±1° C. at 100 rpm using an appropriate spindle of the Brookfield RV-spindle set and is specified in mPa·s.

The following examples are meant to illustrate the invention without restricting its scope.

### Examples

### 1. Measurement Methods

The following measurement methods are used to evaluate the parameters given in the description, examples and claims.

### BET Specific Surface Area of a Material

The BET specific surface area was measured via the BET process according to ISO 9277:2010 using nitrogen, following conditioning of the sample by heating at 250° C. for a period of 30 minutes. Prior to such measurements, the sample was filtered, rinsed and dried at 110° C. in an oven for at least 12 hours.

Particle Size Distribution (Volume % Particles with a Diameter<X) and Weight Median Diameter (d₅₀) of a Particulate Material

Volume median grain diameter d₅₀ was evaluated using a Malvern Mastersizer 3000 Laser Diffraction System. The d₅₀ or d₉₈ value, measured using a Malvern Mastersizer 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005. Weight median grain diameter and grain diameter mass distribution of a particulate material were determined via the sedimentation process, i.e. an analysis of sedimentation behaviour in a gravitational field. The measurement was made with a Sedigraph™ 5120 of Micromeritics Instrument Corporation. The method and the instrument are known to the skilled person and are commonly used to determine grain size of fillers and pigments. The measurement is carried out in an aqueous solution of 0.1 wt.-% Na₄P₂O₇. The samples are dispersed using a high speed stirrer and supersonics.

### pH Measurement

The pH of the water samples is measured at 25° C. by using a Mettler Toledo Seven Easy pH meter and a Mettler Toledo InLab© Expert Pro pH electrode. A three point calibration (according to the segment method) of the instrument was first made using commercially available buffer solutions having pH values of 4, 7 and 10 at 20° C. (from Aldrich). The reported pH values were the endpoint values detected by the instrument (the endpoint was when the measured signal differs by less than 0.1 mV from the average over the last 6 seconds).

### Brookfield-Viscosity

All Brookfield-viscosities are measured with a Brookfield DV-II Viscometer equipped with a LV-3 spindle at a speed of 100 rpm and room temperature (20±3° C.) and are specified in mPa·s. Once the spindle has been inserted into the sample, the measurement is started with a constant rotating speed of 100 rpm. The reported Brookfield viscosity values are the values displayed 60 seconds after the start of the measurement.

### Amount of Additives

Unless otherwise stated, all amounts quoted in ppm represent mg values per kilogram of the obtained product, namely the aqueous home care formulation. Concentrations are further quoted in mmol/kg (millimol per kilogram) or mol/1 (mol per litre) of the aqueous home care formulation according to the International System of Units.

### Total Viable Bacterial Count

All quoted bacterial counts (Total viable counts (TVC) values), unless otherwise indicated, are either given in cfu/ml (colony forming units per millilitre) or cfu/gram (colony forming units per gram) wherein cfu/ml and cfu/gram were determined after 2-3 days following plate-out and incubation at 30° C. and in accordance with counting method described in “Bestimmung von aeroben mesophilen Keimen”, Schweizerisches Lebensmittelbuch, chapter 56, section 7.01, edition of 1985, revised version of 1988. Unless otherwise stated, per tryptic soy agar plate (TSA, prepared using BD 236950) 0.1 ml of a 1:10 dilution in phosphate buffered saline (PBS; pH=7.4, 137 mmol/l NaCl, 2.7 mmol/l KCl, 10 mmol/l Na₂HPO₄, 1.8 mmol/l KH₂PO₄) was plated. TSA plates were then incubated for 48 h or 72 h at 30° C. Colony forming units (cfu) were then counted and reported as cfu/ml or cfu/gram. Counts from of 100 000 cfu/ml and above are reported as 100 000 cfu/ml.

### Solids Content

The solids content (also known as “dry weight”) is measured using a Moisture Analyzer MJ33 of Mettler-Toledo, Switzerland, with the following settings: temperature of 120° C., automatic switch off 3, standard drying, 5 to 20 g of product. The method and the instrument are known to the skilled person.

### Materials:

water soluble or water dispersible source of bismuth ions: bismuth chloride (BiCl₃), CAS: 7787-60-2; bismuth oxide (Bi₂O₃) CAS: 1304-76-3
water soluble or water dispersible source of lithium ions: lithium citrate (Li₃C₆H₅O₇) CAS: 919-16-4, lithium carbonate (Li₂CO₃) CAS: 554-13-2
water dispersible source of magnesium ions: Precipitated hydromagensite (PHM), having a d₅₀ (vol)=8.9 μm and a BET=54.7 m²/g
water soluble or water dispersible source of alkali ions: sodium carbonate (Na₂CO₃) CAS: 497-19-8,

### Preparation of Bacteria, Yeast and Mould Used

Fresh bacteria cultures of the bacteria Pseudomonas sp., e.g. P. aeruginosa DSM-1707 and P. putida DSM-50906, P. pseudoalcaligenes DSM-50188T, Alcaligenes faecalis, e.g. A. faecalis ATCC-25094, Escherichia coli DSM-1576, and Staphylococcus aureus, e.g. S. aureus strains DSM 346, Enterobacter cloacae, e.g. E. cloacae ATCC BAA-234 and fresh Yeast cultures of Saccharomyces cervisiae DSM-1333; Pichia membranifaciens DSM-70179, and Rhodotorula mucilaginosa DSM-18184, were prepared by inoculation of 3 ml liquid growth media (tryptic soy broth, e.g. Fluka, No. 22092) from a single colony of a stock culture and incubation for 16 to 20 h at 30° C. with agitation at 150 rotations per minutes (rpm) leading to a cell density of approximately 1×10⁹ cells/ml. Over-night cultures of bacteria/yeast and fungi (in tryptic soy broth) were mixed together in equal quantities, 100 μl of the obtained mixture was added to 50 ml of base formulation comprising the storage stabilization agent.

### Base Formulation

The ingredients of the base formulation for testing antimicrobial activity are summarized in the following table 1.

TABLE 1
Ingredients of the base formulation

| base formulation | wt.-% |
|---|---|
| coconut fatty acid | 5.5 |
| potassium hydroxide 50% w/v aqueous solution | 2.2 |
| alkane sulfonate (Hostapur SAS 60) | 8.7 |
| Lutensol AO7 (surfactant based on ethoxylated fatty alcohol | 10.1 |
| 7EO) | |
| 1,2-propyleneglycol | 1.0 |
| water, 40-50° C., desalinated | ad 100 |
| pH | 8-9 |

For the preparation of the base formulation the coconut fatty acid and the potassium hydroxide have been mixed under stirring under room temperature. Afterwards, desalinated water with a temperature between 4° and 50° C. is added under stirring. To the homogeneous mixture the alkane sulfonate, the Lutensol A07 and the 1,2-propyleneglycol are added successively. The obtained mixture is cooled to room temperature and has a pH value between 8 and 9.

### Experimental Data

### Antimicrobial Activity Tests in the Base Formulation

Samples of the base formulation were mixed with different amounts of a water soluble or water dispersible source of bismuth ions, a water soluble or water dispersible source of lithium ions, a water dispersible source of magnesium ions and at least a water soluble or water dispersible source of alkali ions according to claim 1 as set out in Tables 2 to 5 below.

All amounts quoted in ppm correspond to mg values per kilogram of the corresponding ion based on the total weight of the base formulation.

The base formulations E1 to E32 comprising the antimicrobial compositions according to Tables 2 to 4 were prepared, and the antimicrobial activity was weekly tested over a period of 6 weeks (T0 to T6) in order to evaluate the long term effect of the storage stabilization and especially the antimicrobial activity of the added storage stabilization agent in the base formulation. Aliquots of 50 ml of the base formulation comprising the storage stabilisation agent were taken over the 6 weeks and mixed with an aliquot of 100 μl of the over-night cultures of bacteria/yeast and fungi as prepared above, well mixed and incubated at room temperature for one week in the dark. After one week, 100 μl of a 1:10 dilution of a PBS-buffer (Phosphate buffer saline 10 mM, pH 7.4, 137 mmol/l NaCl, 2.7 mmol/l KCl, 10 mmol/l Na₂HPO₄, 1.8 mmol/l KH₂PO₄) were plated out (100 colony forming units (cfu) per millilitre of paint) on standard TSA (Trypticase soy agar) plates, and incubated at 30° C. in a Binder 3.1 incubator. Samples were analysed after 48 h for growth of bacteria and after 72 h for growth of yeast/fungi/mould.

When not otherwise indicated, the quoted bacterial/yeast and fungi counts are given as:
− (no growth, <100 cfu/gram),
+ (100-10′000 cfu/gram),
++ (10′000-100′000 cfu/gram), and
+++ (>100′000 cfu/gram).
cfu=colony forming units

TABLE 2
Ingredients of Example 1

| | water soluble or water | water dispersible | | | | | | | | | |
|---|---|---|---|---|---|---|---|---|---|---|---|
| | dispersible source of | source of magnesium | | | | | | | | | |
| | alkali ions (Na₂CO₃) | ions (PHM) | | | | | | | | | |
| Sample | [ppm] | [ppm] | pH_T0 | T0 | T1 | T2 | T3 | T4 | T5 | T6 | pH_T6 |
| E1 | 0 | 0 | 8.56 | − | + | +++ | +++ | +++ | +++ | +++ | 8.03 |
| E2 | 1500 | 0 | 9.03 | − | + | +++ | +++ | +++ | +++ | +++ | 7.64 |
| E3 | 1000 | 0 | 8.92 | − | +++ | +++ | +++ | +++ | +++ | +++ | 7.68 |
| E4 | 0 | 1500 | 9.11 | − | +++ | +++ | +++ | +++ | +++ | +++ | 7.76 |
| E5 | 1500 | 1500 | 9.83 | − | − | − | − | − | − | − | 9.8 |

TABLE 3
Ingredients of Example 2

| | water soluble | water soluble | | | | | | | | | | |
|---|---|---|---|---|---|---|---|---|---|---|---|---|
| | or water | or water | | water soluble or | | | | | | | | |
| | dispersible | dispersible | water dispersible | water dispersible | | | | | | | | |
| | source of | source of | source of | source of bismuth | | | | | | | | |
| | alkali ions | lithium ions | magnesium ions | ions | | | | | | | | |
| | (Na₂CO₃) | (lithium | (PHM) | (bismuth | | | | | | | | pH |
| Sample | [ppm] | cltrat) [ppm] | [ppm] | chloride) [ppm] | T0 | T1 | T2 | T3 | T4 | T5 | T6 | T6 |
| E6 | 1500 | 1500 | 0 | 0 | − | − | − | − | − | − | − | 9.17 |
| E7 | 1500 | 0 | 0 | 1500 | − | − | − | − | − | − | − | 9.28 |
| E8 | 0 | 1500 | 1500 | 0 | − | − | − | − | − | − | − | 9.48 |
| E9 | 0 | 0 | 0 | 0 | − | ++ | +++ | +++ | +−+ | +++ | +++ | 8.03 |

TABLE 4
Ingredients of Example 3

| | | water soluble | | | | | | | | | | |
|---|---|---|---|---|---|---|---|---|---|---|---|---|
| | | or water | | | | | | | | | | |
| | water soluble or | dispersible | water dispersible | water soluble or | | | | | | | | |
| | water dispersible | source of | source of | water dispersible | | | | | | | | |
| | source of lithium | alkali ions | magnesium ions | source of | | | | | | | | |
| | ions (Li₂CO₃) | (Na₂CO₃) | (PHM) | bismuth ions | | | | | | | | |
| Sample | [ppm] | [ppm] | [ppm] | (Bi₂O₃) [ppm] | T0 | T1 | T2 | T3 | T4 | T5 | T6 | pH |
| E10 | 0 | 0 | 0 | 0 | − | ++ | +++ | −++ | +++ | +++ | +++ | 7.86 |
| E11 | 0 | 1000 | 0 | 0 | − | + | +++ | + | +++ | +++ | +++ | 7.76 |
| E12 | 250 | 1000 | 0 | 0 | − | − | − | − | − | − | − | 9.35 |
| E13 | 250 | 0 | 1500 | 0 | − | − | − | − | − | − | − | 9.82 |
| E14 | 250 | 0 | 0 | 0 | − | − | +++ | −++ | +++ | +++ | +++ | 7.83 |
| E15 | 0 | 0 | 0 | 1000 | − | − | +++ | −++ | +++ | +++ | +++ | 7.78 |
| E16 | 0 | 1000 | 0 | 1000 | − | − | − | − | − | − | − | 9.23 |

TABLE 5
Ingredients of Example 4

| | | | | water soluble | | | | | | | | | |
|---|---|---|---|---|---|---|---|---|---|---|---|---|---|
| | | water soluble | water soluble | or water | | | | | | | | | |
| | water | or water | or water | dispersible | | | | | | | | | |
| | dispersible | dispersible | dispersible | source of | | | | | | | | | |
| | source of | source of | source of | alkali ions | | | | | | | | | |
| | magnesium ions | lithium ions | bismuth ions | (Na₂CO₃) | Sum of | | | | | | | | |
| Sample | (PHM) [ppm] | (Li₂CO₃) [ppm] | (Bi₂O₃)_[ppm] | [ppm] | components | T0 | T1 | T2 | T3 | T4 | T5 | T6 | pH |
| E17 | 0 | 0 | 0 | 0 | 0 | − | − | +++ | +++ | +++ | +++ | +++ | 7.97 |
| E18 | 0 | 2500 | 2500 | 0 | 5000 | − | − | − | − | − | − | − | 9.82 |
| E19 | 1666 | 1666 | 1666 | 0 | 5000 | − | − | − | − | − | − | − | 10.09 |
| E20 | 2500 | 0 | 2500 | 0 | 5000 | − | − | − | − | − | − | − | 9.86 |
| E21 | 1200 | 1200 | 0 | 1200 | 3600 | − | − | − | − | − | − | − | 10.03 |
| E22 | 2500 | 2500 | 0 | 0 | 5000 | − | − | − | − | − | − | − | 10.06 |
| E23 | 1666 | 0 | 1666 | 1666 | 5000 | − | − | − | − | − | − | − | 9.99 |
| E24 | 0 | 1666 | 1666 | 1666 | 5000 | − | − | − | − | − | − | − | 9.71 |
| E25 | 0 | 2500 | 0 | 2500 | 5000 | − | − | − | − | − | − | − | 9.91 |
| E26 | 0 | 0 | 0 | 2500 | 2500 | − | − | ++ | ++ | −+ | ++ | − | 9.19 |
| E27 | 2500 | 0 | 0 | 2500 | 5000 | − | − | − | − | − | − | − | 9.88 |
| E28 | 1666 | 0 | 1500 | 0 | 3000 | − | − | − | − | − | − | + | 9.58 |
| E29 | 0 | 0 | 2500 | 2500 | 5000 | − | − | − | − | − | − | − | 9.28 |
| E30 | 0 | 0 | 2500 | 0 | 2500 | − | − | − | − | − | ++ | ++ | 7.67 |
| E31 | 0 | 1000 | 1000 | 1000 | 3000 | − | − | − | − | − | − | − | 9.27 |
| E32 | 0 | 0 | 5000 | 0 | 5000 | − | − | − | + | + | ++ | ++ | 8.2 |

From the data of tables 2 to 5 it can be seen that the samples E1, E9, E10 and E17 are control samples that do not comprise any storage stabilization agent. It can be seen that already after one week the bacterial/yeast and fungi counts increase dramatically and no storage stabilization is given.

From table 2 it can be seen that the use of a water soluble or water dispersible source of alkali ions, wherein the water soluble or water dispersible source of alkali ions is selected from alkali carbonate and/or alkali bicarbonate (samples E2 and E3) and the use of a water dispersible source of magnesium ions, wherein the water dispersible source of magnesium ions is selected from magnesium carbonate or magnesite (MgCO₃) and/or hydromagnesite (Mg₅(CO₃)₄(OH)₂·4H₂O) (sample E4) alone is not able to stabilize the base formulation over the 6 weeks. However, if these compounds are used in combination, no bacterial/yeast and fungi growth is detectable.

From table 3, it can be seen that the storage stabilization agent of the present invention that comprises at least two different water soluble or water dispersible ion sources selected from the group consisting of water soluble or water dispersible source of bismuth ions, water soluble or water dispersible source of lithium ions, water dispersible source of magnesium ions and at least a water soluble or water dispersible source of alkali ions according to claim 1 can indeed stabilize the base formulations upon storage.

The same can be seen from table 4. It can be seen that the use of a water soluble or water dispersible source of alkali ions, wherein the water soluble or water dispersible source of alkali ions is selected from alkali carbonate and/or alkali bicarbonate (sample E11) and the use of a water dispersible source of magnesium ions, wherein the water dispersible source of magnesium ions is selected from magnesium carbonate or magnesite (MgCO₃) and/or hydromagnesite (Mg₅(CO₃)₄(OH)₂·4H₂O) (sample E4) and the use of water soluble or water dispersible source of bismuth ions (sample E15) and the water soluble or water dispersible source of lithium ions (sample E14) alone is not able to stabilize the base formulation over the 6 weeks. However, if at least two of these compounds are used in combination (sample E12: alkali ions in combination with lithium ions; sample E13: lithium ions in combination with magnesium ions; sample E16: bismuth ions in combination with alkali ions), no bacterial/yeast and fungi growth is detectable.

The same can be seen from table 5. It can be seen that the use of a water soluble or water dispersible source of alkali ions, wherein the water soluble or water dispersible source of alkali ions is selected from alkali carbonate and/or alkali bicarbonate (sample E26) and the use of water soluble or water dispersible source of bismuth ions (samples E30 and E32) alone is not able to stabilize the base formulation over the 6 weeks. However, if at least two or three of these compounds are used in combination (samples E18 to E25, E27 to E29 and E31), no bacterial/yeast and fungi growth is detectable.

Therefore, the use of the inventive storage stabilization agent stabilizes the aqueous home care formulation upon storage, especially the aqueous home care formulations is stabilized for a defined amount of time against microorganisms and especially against bacterial/yeast and fungi growth.

1-10. (canceled)

11. Storage stabilization agent for stabilizing an aqueous home care formulation upon storage, comprising at least two different water soluble or water dispersible ion sources selected from the group consisting of water soluble or water dispersible source of bismuth ions, water soluble or water dispersible source of lithium ions, water dispersible source of magnesium ions and at least on water soluble or water dispersible source of alkali ions,
wherein the water soluble or water dispersible source of alkali ions is selected from alkali carbonate and/or alkali bicarbonate and
wherein the water dispersible source of magnesium ions is selected from magnesium carbonate or magnesite (MgCO₃) and/or hydromagnesite (Mg₅(CO₃)₄(OH)₂·4H₂O).

12. An aqueous home care formulation comprising the storage stabilization agent according to claim 11.

13. The aqueous home care formulation according to claim 12, wherein the storage stabilization agent is present in an amount such that the aqueous home care formulation is preserved against microorganisms for at least 15 days.

14. Process for stabilizing an aqueous home care formulation upon storage, said process comprises the steps of
a) providing an aqueous home care formulation,
b) providing a storage stabilization agent as defined in claim 11, and
c) contacting and mixing the aqueous home care formulation of step a) with the storage stabilization agent of step b) in any order for obtaining the stabilized aqueous home care formulation.

15. The storage stabilization agent according to claim 11, wherein the water soluble or water dispersible source of bismuth ions is at least one bismuth compound.

16. The storage stabilization agent according to claim 15, wherein the at least one bismuth compound is selected from the group consisting of bismuth carbonate, bismuth subcarbonate, bismuth oxide, bismuth hydroxide, bismuth chloride, bismuth iodide, bismuth phosphate, bismuth citrate, bismuth acetate, bismuth lactate, bismuth subsalicylate, polymeric compounds of bismuth and mixtures thereof.

17. The storage stabilization agent according to claim 11, wherein the at least one water soluble or water dispersible source of lithium ions is at least one lithium salt.

18. The storage stabilization agent according to claim 17, wherein the at least one lithium salt is selected from lithium carbonate, lithium chloride, lithium hydroxide, lithium phosphate, lithium citrate, lithium maleate, lithium acetate and lithium lactate; polymeric salts of lithium and mixtures thereof.

19. The storage stabilization agent according to claim 11,
a) wherein the at least one dispersible source of magnesium ions is hydromagnesite, and/or
b) wherein the water dispersible source of magnesium ions is in form of particles having
i) a volume median grain diameter (d₅₀) of ≥150 nm, and/or
ii) a volume determined top cut particle size (d₉₈) of equal to or less than 30 μm, or
c) wherein the water dispersible source of magnesium ions is in form of granules having
i) a volume median particle size d₅₀ of from 5 to 300 μm, as determined by laser diffraction, and
ii) a volume particle size d₉₀ of from 15 to 500 μm, as determined by laser diffraction and
iii) a volume particle size d₁₀ of from 1 to 100 μm, as determined by laser diffraction.

20. The storage stabilization agent according to claim 11, wherein the alkali carbonate is selected from the group consisting of sodium carbonate, potassium carbonate, lithium carbonate, and mixtures thereof.

21. The storage stabilization agent according to claim 11, wherein each of the water soluble or water dispersible sources of ions are present in the composition in an amount from 1000 to 50000 ppm, based on the total weight of the home care formulation.

22. The storage stabilization agent according to claim 11, wherein the weight ratio of the at least two different water soluble or water dispersible ion sources is from 100:1 to 1:100.

23. The storage stabilization agent according to claim 11, wherein the storage stabilization agent comprises further additives selected from the group consisting of dispersing agents, viscosity agents, thickeners, rheological additives and defoaming agents.

24. The storage stabilization agent according to claim 11, wherein the at least two different water soluble or water dispersible ion sources are a water dispersible source of magnesium ions and at least a water soluble or water dispersible source of alkali ions, wherein the water soluble or water dispersible source of alkali ions is selected from alkali carbonate and/or alkali bicarbonate and wherein the water dispersible source of magnesium ions is selected from magnesium carbonate or magnesite (MgCO₃) and/or hydromagnesite (Mg₅(CO₃)₄(OH)₂·4H₂O).

25. The storage stabilization agent according to claim 11, wherein the microorganisms are selected from the group comprising at least one strain of bacteria, at least one strain of fungi, mold or yeast, algae and mixtures thereof.

26. The aqueous home care formulation according to claim 12, wherein the home care formulation is a washing formulation; a pre-washing formulation; a rinsing formulation; a bleaching formulation; a laundry fabric-softener formulation; a cleaning formulation; and mixtures thereof.

27. The aqueous home care formulation according to claim 12, wherein the storage stabilization agent is present in an amount such that the aqueous home care formulation is preserved against microorganisms for at least 90 days.
